(19) United States
(12) Patent Application Publication
(10) Pub. No.: US 2002/0159641 A1
(43) Pub. Date: Oct. 31, 2002

(54) Directed dynamic data analysis

(76) Inventors: Paul D. Whitney, Richland, WA (US); Susan L. Havre, Richland, WA (US); Elizabeth G. Hetzler, Kennewick, WA (US); Kenneth A. Perrine, Richland, WA (US); John D. Wiberg, Richland, WA (US)

Correspondence Address: Killworth, Gottman, Hagan & Schaeff, L.L.P., Suite 500, One Dayton Centre, Dayton, OH, 45402-2023, US

(21) Appl. No.: 10/097,719

(22) Filed: Mar. 13, 2002

Related U.S. Application Data
(60) Provisional application No. 60/275,882, filed on Mar. 14, 2001.

(51) Int. Cl. G06K 9/68

(52) U.S. Cl. 382/219

(57) ABSTRACT

Several approaches are provided for designing algorithms that allow for fast retrieval, classification, analysis or other processing of data, with minimal expert knowledge of the data being analyzed, and further, with minimal expert knowledge of the math and science involved in building classifications and performing other statistical data analysis. Further, methods of analyzing data are provided where the information being analyzed is not easily susceptible to quantitative description.

### CROSS REFERENCE TO RELATED APPLICATIONS

This application claims priority of Provisional application No. 60/275,882 filed Mar. 14, 2001, which is herein incorporated by reference.

### BACKGROUND OF THE INVENTION

This invention relates generally to the field of data analysis, and more particularly to systems and methods for generating algorithms useful in pattern recognition, classifying, identifying, characterizing, or otherwise analyzing data.

Pattern recognition systems are useful for a broad range of applications including optical character recognition, credit scoring, computer aided diagnostics, numerical taxonomy and others. Broadly, pattern recognition systems have a goal of classification of unknown data into useful, sometimes predefined, groups. Pattern recognition systems typically have two phases: training/construction and application. In the application of a pattern recognition system, pertinent features from an input data object are collected and stored in an array referred to as a feature vector. The feature vector is compared to predefined rules to ascertain the class of the object i.e. the input data object is identified as belonging to a particular class if the pertinent features extracted into the feature vector fall within the parameters of that class. As such, the success of a pattern recognition system depends largely on the proper training and construction of the classes with respect to the aspects of the data objects being addressed by the analysis.

In a perfect classifier system, every data object being analyzed fits into a unique and correct class. That is, the input feature vector that defines the data object does not overlap two or more classes and the feature vector is mapped to the correct class (e.g. the letter or word is correctly identified, a credit risk is correctly assessed, the correct diagnostic is derived etc). This scenario however, is far from realistic in numerous real world applications. For example, in some applications, the characteristics or features that separate the classes are unknown. It is thus left to the education, skill, training and experience of persons constructing the classifier to determine the features of the input data objects that effectively capture the class differences, and to correctly and identify the degree to which the pattern recognition system fails to perform. This process often requires the skill and knowledge of highly trained experts from diverse technical fields who must analyze vast amounts of data to yield satisfactory results.

In building a classifier system, experts are required not only in the field of endeavor, but also in the field of algorithm generation. The result is that it is costly to build a pattern recognition system. This high cost is born out not only in the expensive experts that are required to build the classifier, but also in the high number of worker-hours required to solve the problem at hand. Even after investing in the long and costly development periods, the quality of the pattern recognition system is still largely contingent on the skill of the particular experts constructing the classifier. Further, where the experts building the classes have limited data from which to build the classes, results can vary widely.

Accordingly, there is a need for methods and systems directed to effectively generating algorithms useful for classifying, identifying or otherwise analyzing information.

### SUMMARY OF THE INVENTION

The present invention overcomes the disadvantages of previously known pattern recognition or classifier systems by providing several approaches for designing algorithms that allow for fast feature selection, feature extraction, retrieval, classification, analysis or other processing of data. Such approaches may be implemented with minimal expert knowledge of the data objects being analyzed. Additionally, minimal expert knowledge of the math and science behind building classifiers and performing other statistical data analysis is required. Further, methods of analyzing data are provided where the information being analyzed is not easily susceptible to quantitative description.

Therefore, it is an object of the present invention to provide systems and methods for generating algorithms useful for selecting, classifying, quantifying, identifying or otherwise analyzing information, notably image sensor information.

It is an object of the present invention to provide systems and methods for classifier development and evaluation that integrate feature selection, classifier training, and classifier evaluation into an integrated environment.

Other objects of the present invention will be apparent in light of the description of the invention embodied herein.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is a block diagram of a pattern recognition construction system according to one embodiment of the present invention;

FIG. 2 is a block diagram of a pattern recognition construction system that provides for continuous learning according to one embodiment of the present invention;

FIG. 3 is a block diagram of a pattern recognition construction system according to another embodiment of the present invention;

FIG. 4 is a block diagram of a pattern recognition construction system according to another embodiment of the present invention;

FIG. 5 is a flow diagram of a pattern recognition construction system according to one embodiment of the present invention;

FIG. 6 is a block diagram of a computer architecture for performing pattern recognition construction and classifier evaluation according to one embodiment of the present invention;

FIG. 7 is a flow chart illustrating a user-guided automatic feature generation routine according to one embodiment of the present invention;

FIG. 8 is a flow chart illustrating a computer-implemented approach for feature selection and generation according to one embodiment of the present invention;

FIG. 9 is a flow chart of illustrating the steps for a dynamic data analysis approach for analyzing data according to one embodiment of the present invention;

FIG. 10 is a flow chart of a method to implement dynamic data analysis according to one embodiment of the present invention;

FIG. 11 is an illustration of an exemplary computer program arranged to implement dynamic data analysis according to one embodiment of the present invention;

FIG. 12 is an illustration of the exemplary computer program according to FIG. 11 wherein no rules have been established, and data objects are projected in a first pattern;

FIG. 13 is an illustration of the exemplary computer program according to FIGS. 11 and 12 wherein a rule has been established, and the data objects have been re-projected based upon that rule;

FIG. 14 is a flow chart illustrating a method of calculating features from a collection of data objects according to one embodiment of the present invention;

FIG. 15 is a flow chart illustrating a first example of an alternative approach to the method of FIG. 14;

FIG. 16 is a flow chart illustrating a second example of an alternative approach to the method of FIG. 14;

FIG. 17 is an illustration of various ways to extract segments from an object according to one embodiment of the present invention;

FIG. 18 is a block diagram of a classifier refinement system according to one embodiment of the present invention;

s FIG. 19 is a block diagram of a method for classifier evaluation according to one embodiment of the present invention;

FIG. 20A is a block diagram illustrating the segmentation process according to one embodiment of the present invention;

FIG. 20B is an illustration of a field of view used to generate a segmentation classifier of FIG. 20A according to one embodiment of the present invention;

FIG. 20C is an illustration of the field of view of FIG. 20B illustrating clustering of areas of interest according to one embodiment of the present invention;

FIG. 20D is an illustration of a view useful for generating a segmentation classifier of FIGS. 2OA-20C where view presents data that is missing after segmentation according to one embodiment of the present invention; and,

FIG. 20E is a flow chart of the general approach to building a segmentation classifier according to one embodiment of the present invention.

### DETAILED DESCRIPTION OF THE PREFERRED EMBODIMENTS

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that logical changes may be made without departing from the spirit and scope of the present invention. Further, like structure in the drawings is indicated with like reference numerals.

Definitions:

A Data Object is any type of distinguishable data or information. For example, a data object may comprise an image, video, sound, text, or other type of data. Further, a single data object may include multiple types of distinguishable data. For example, video and sound may be combined into one data object, an image and descriptive text may be combined, different imaging modalities may also be combined. A data object may also comprise a dynamic, one-dimensional signal such as a time varying signal, or n-dimensional data, where n is any integer. For example, a data object may comprise 3-D or higher order dimensionality data. A data object as used herein is to be interpreted broadly to include stored representations of data including for example, digitally stored representations of source phenomenon of interest.

A Data Set is a collection of data objects. For example, a data set may comprise a collection of images, a plurality of text pages or documents, a collection of recorded sounds or electronic signals. Distinguishable or distinct data objects are different to the extent that they can be recognized as different from the remaining data objects in a data set.

A segment is information or data of interest derived within a data object and can include a subset, part, portion, summary, or the entirety of the data object. A segment may further comprise calculations, transformations, or other processes performed on the data object to further distinguish the segment. For example, where a data object comprises an image, a segment may define a specific area of interest within the image.

A Feature is any attribute or property of a data object that can be distinguished, computed, measured, or otherwise identified. For example, if a data object comprises an image, then a feature may include hue, saturation, intensity, texture, shape, or a distance between two pixels, If the data object is audio data, a feature may include volume or amplitude, the energy at a specific frequency or frequency range, noise, and may include time series or dynamic aspects such as attack, decay etc. It should be observed that the definition of a feature is broad and encompasses not only focusing on a segment of the data object, but may also require computation or other analysis over the entire data object.

A Feature Set is a collection of features grouped together and is typically expressed as an array. Thus in general terms, a feature set X is an n-dimensional array consisting of features x₁, x₂, . . . xₙ₋₁, xₙ. Accordingly, n represents the number of attributes or features presented in the feature set. A feature set may also be represented as a member of a linear space; in particular, there's no restriction that the number or dimensionality of features is the same for each data.

A Feature Vector is an n-dimensional array that contains the values of the features in a feature set extracted from the analysis of a data object.

A Feature Space is the n-dimensional space in which a feature vector represents a single point when plotted.

A Class is defined by unique regions established from a feature space. Classes are usually selected to differentiate or sort data objects into meaningful groups. For example, a class is selected to define a source phenomenon of interest.

A Signature refers to the range of values that make up a particular class.

Classification is the assignment of a feature vector to a class. As used herein, classifiers may include, but are not limited to classifiers, characterizations, and quantifiers, such as the case where a numeric score is given for a particular information analysis.

Primitives are attributes or features that appear to exist globally over all types of image data, or at the least over a broad range of data types.

User is utilized generically herein to refer to a human operator, a software agent, process, device, or any thing capable of executing a process or control.

### Automatic Generation Of A Feature Set And Classifier For Pattern Recognition

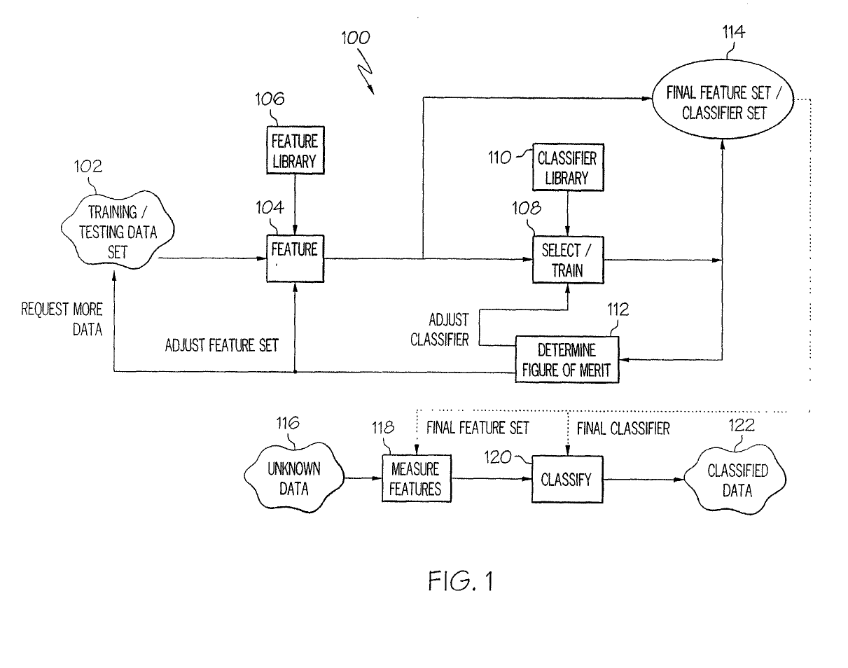

FIG. 1 illustrates an automated pattern recognition process 100 according to one embodiment of the present invention. The pattern recognition process 100 is also referred to herein as a pattern recognition construction process 100 as it can be applied across diverse data types and used in virtually any field of application where it is desirable to build or train classifiers, evaluate classifier performance, or perform other types of pattern recognition.

When the various embodiments of the present invention are implemented in the form of systems or computer solutions, the various described processes may be implemented as modules or operations of the system. For example, the feature process 104 may be implemented as a feature module, the training process 108 may be implemented as a training module, and the effectiveness process 112 may be implemented as an effectiveness module. The term module is not meant to be limiting, rather, it is used herein to differentiate the various aspects of the pattern recognition system. In actual implementations, the modules may be combined, integrated, or otherwise implemented individually. For example, where the pattern recognition construction process 100 is implemented as a computer solution, the various components may be implemented as modules or routines within a single software program, or may be implemented as discrete applications that are integrated together. Still further, the various components may include combinations of dedicated hardware and software.

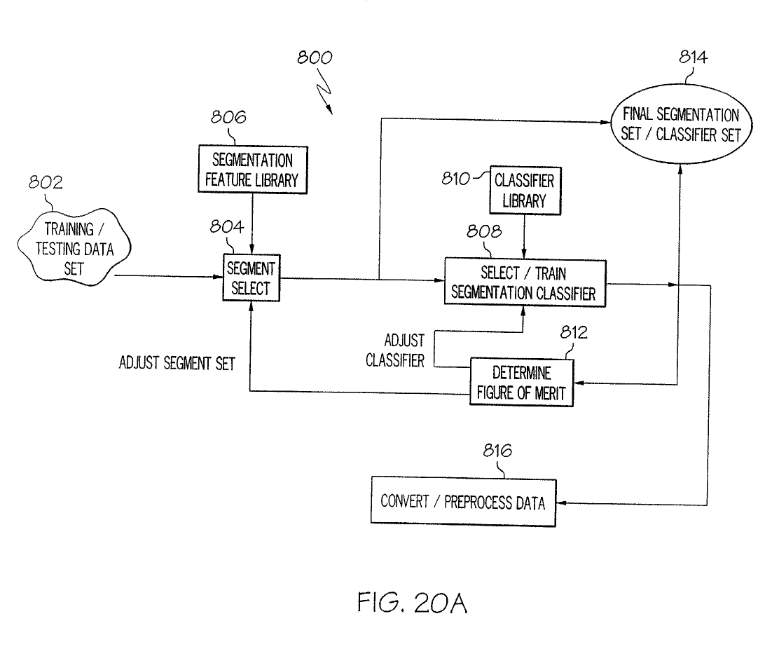

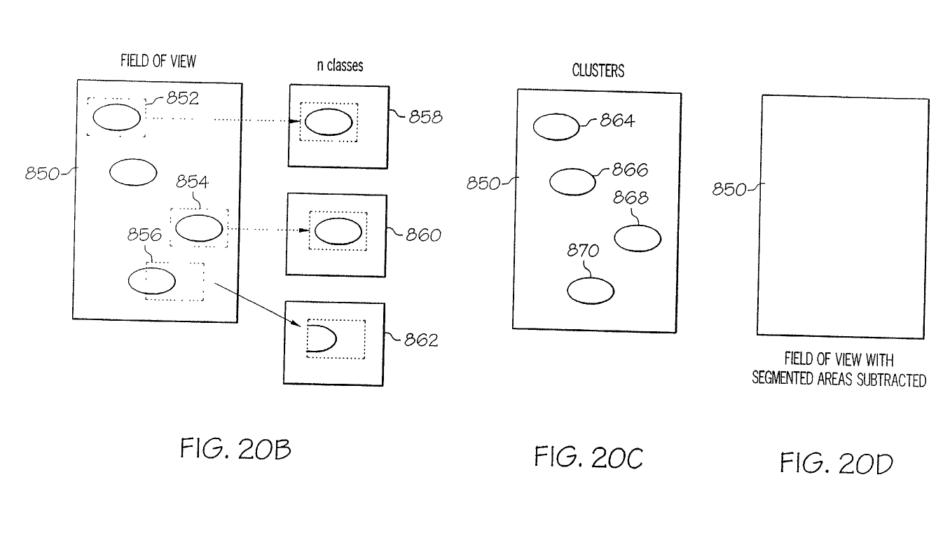

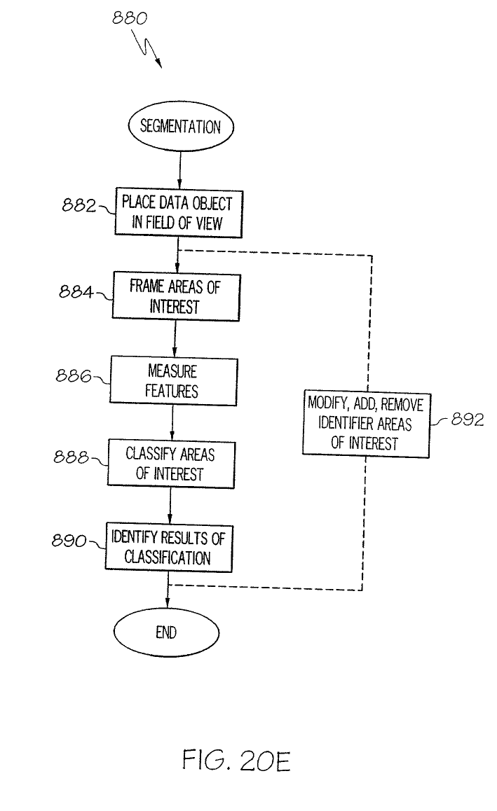

The pattern recognition construction process 100 analyzes a group of data objects defining a data set 102. The data set 102 preferably comprises a plurality of pre-classified data objects including data objects for training as well as data objects for testing at least one classifier as more fully explained herein. One example of a method and system for constructing the classified data is through a segmentation process illustrated and discussed herein with reference to FIGS. 20A-20E.

A feature process 104 selects and extracts feature vectors from the data objects 102 based upon a feature set. The feature set may be generated automatically, such as from a collection of primitives, from pre-defined conditions, or from a software agent or process. Under this approach, the user does not have to interact with the data to establish features or to create a feature set. For example, where the feature process 104 has access to a sufficient quantity, quality, and combination of primitives or predefined conditions, a robust system capable of solving most or all data classifying applications automatically, or at least with minimal interaction, may be realized.

Alternatively, the feature set may be generated at least partially, from user input, or from any number of additional processes. The feature set may also be derived from any combination of automated or pre-defined features and user-based feature selection. For example, a candidate feature set may be derived from predefined features as modified or supplemented by user-guided selection of features. According to one embodiment of the present invention, the feature process 104 is completely driven by automated processes, and can derive a feature set and extract feature vectors across the data set 102 without human intervention. According to another embodiment of the present invention, the feature process 104 includes a user-guided candidate feature selection process such that at least part of feature selection and extraction can be manually implemented.

As will be seen more fully herein, the pattern recognition construction process 100 provides an iterative, feedback driven approach to creating a pattern recognition algorithm. In a typical application, the initial feature set used to extract feature vectors may not comprise the optimal, or at least ultimate set of features. Accordingly, during processing, the feature set will also be referred to as a candidate feature set to indicate that the candidate features that define the feature set might be changed or otherwise altered during processing.

The candidate feature set may also be determined in part or in whole from candidate features obtained from an optional feature library 106. The optional feature library 106 can be implemented in any number of ways. However a preferred approach is to provide an extensible library that contains a plurality of features organized by domain or application. For example, the feature library 106 may comprise a first group of features defining a collection of general primitives. A second group may comprise features or primitives selected specifically for cytology, tissue, bone, organ or other medical applications. Other examples of specialized groups may include manufactured article surface defect applications, audio cataloging applications, or video frame cataloging and indexing applications. Still further examples of possible groups may include still image cataloging, or signatures for military and target detection applications.

The feature library 106 is preferably extensible such that new features may be added or edited by users, programmers, or from other sources. For example, where the pattern recognition construction process 100 is embodied in a machine including turnkey systems, or as computer code for execution on any desired computer platform, the feature library 106 might be provided as updateable firmware, upgradeable software, or otherwise allow users access and editing to the library data contained therein.

The training process 108 analyzes the feature vectors extracted by the feature process 104 to select and train an appropriate classifier or classifiers. The term classifier set is used herein to refer to the training of at least one classifier, and can include any number of classifiers. The training process 108 is not necessarily tied to particular classifier schemes or classifier algorithms. Rather, any number of classifier techniques may be tried, tested, and modified. Accordingly, it is preferable that more than one classifier is explored, at least initially.

In a typical application, the classifiers in the classifier set trained from the candidate feature vectors may not comprise the optimal, or at least ultimate classifiers. Accordingly, during processing, classifiers will also be referred to as a candidate classifiers indicating that each classifier in a classifier set may be selected, deselected, modified, tested, trained, or otherwise modified. This includes modifying the algorithm that defines the classifier, changing classifier parameters or conditions used to train the classifier, and retraining the candidate classifiers due to the availability of additional feature vectors, or the modification of the available feature vectors. Likewise, the classifier set will also be referred to as a candidate classifier set to indicate that the candidate classifiers that define the classifier set might be modified, added, deleted, or otherwise altered during processing.

The training process 108 may be implemented so as to run in a completely automated fashion. For example, the candidate classifiers may be selected from initial conditions, a software agent, or by any number of other automated processes. Alternatively, some human interaction with the training process 108 may optionally be implemented. This may be desirable where user-guided classifier selection or modification is implemented. Still further, the training process 108 may be implemented to allow any combination of automation and human user interaction.

The training process 108 may include or otherwise have access to an optional classifier library 110 of classifier algorithms to facilitate the selection of one or more of the candidate classifiers. The classifier library 110 may include for example, information sufficient to enable the training process 108 to train a candidate classifier using linear discriminant analysis, quadratic discriminant analysis, one or more neural net approaches, or any other suitable algorithms. The classifier library 110 is preferably extensible, meaning that the classifier library 110 may be modified, added to, and otherwise edited in an analogous fashion to that described above with reference to the feature library 106.

An effectiveness process 112 determines at least one figure of merit, also is referred to herein as a performance measure for the candidate classifiers trained by the training process 108. The effectiveness process 112 enables refinement of the candidate classifiers based upon the performance measure. Feedback is provided to the feature process 104, to the training process 108, or to both. It should be appreciated that no feedback may be required, a first feedback path may be required to the feature process 104, or a second feedback path may be required to the training process 108. Thus the first feedback path provided from the effectiveness process 112 to the feature process 104 is preferably independent from the second feedback path from the effectiveness process 112 to the training process 108.

The performance measure is used to direct refinement of the candidate classifier. This can be accomplished in any number of ways. For example, the effectiveness process 112 may make the performance measure(s) available either directly, or in some summarized form to the feature process 104 and the training process 108, and leave the interpretation thereof, to the appropriate process. As an alternative example, the effectiveness process 112 may direct the desired refinements required based upon the performance measure(s) to the appropriate one of the feature process 104 and the training process 108. The exact implementation of refinement will depend upon the implementation of the feature process 104 and the training process 108. Accordingly, depending upon the implementation of the effectiveness process 112, feedback to either the feature process 104 or the training process 108 may be applied as either a manual or automatic process. Further, the feedback preferably continues as an iterative process until a predetermined stopping criterion is met. For each iteration of the system, changes may be made to the candidate feature set, the candidate classifiers or the feature vectors extracted based upon the candidate feature set, and a new performance measure is determined. Through this iterative feedback approach, a robust classifier can be generated based upon a minimal training set, and preferably, with minimal to no human intervention.

The term “performance measure” as used herein is to be interpreted broadly to include metrics of classifier performance, indications (i.e., weights) of which features influence a particular developed (trained) classifier, and other forms of data analysis that understand the respective features that dictate classifier performance and infers refinements to the classifiers (or data prior to classification). Performance measures can take the form of reports, data outputs, lists, rankings, tables, summaries, visual displays, plots, and other means that convey an analysis of classifier performance. For example, the performance measure may enable refinement of the candidate classifiers by determining links between the complete data object readily classified by expert review, and the extractable features necessary to automatically accomplish the classification must be appreciated, which can be used to optimize the feature set.

It is likely that the algorithms selected during the training process 108 will yield highly accurate results. However, there is the possibility that the results may improve with human interaction. Accordingly, the effectiveness process 112 may create a window of opportunity, or otherwise allow for user interaction with the performance measure(s) to affect the feedback to either of the feature and training processes 104, 108, and the changes made thereto.

The effectiveness process 112 can be used to refine the candidate classifiers in any number of ways. For example, the effectiveness process 112 may report a performance measure that suggests there is insufficient feature vector data, or alternatively, that the candidate classifiers may be improved by providing additional feature vector data. Under this arrangement, the effectiveness process 112 feeds back to the feature process 104, where additional feature vectors may be extracted from the data set 102. This may require obtaining additional data objects, or obtaining feature vectors from alternative data sets for example. Upon extracting the additional feature vectors, the training process 108 refines the training of the candidate classifier set on the new feature vectors, and the effectiveness process 112 computes a new performance measure.

Another alternative to refine the candidate classifiers is to modify the candidate feature set. This may comprise for example, adding features, removing features, or modifying the manner in which existing features are extracted. For example, a feature may be modified by adding pre-emphasis, de-emphasis, filtering, or other processing to the data objects before a particular feature is extracted. Typically, the data set 102 can be divided into features any number of ways. However, some features will be of absolutely no value in a particular classification application. Further, pertinent features will have varying degrees of applicability in classifying the data. Thus one of the primary challenges in pattern recognition is reducing the candidate feature set to pertinent or meaningful features.

Poor feature set selection can cripple or otherwise render ineffective a classification system. For example, by selecting too few features, poor classification accuracy results. On the opposite spectrum, too many features in the candidate feature set can also decrease classification accuracy. Extraneous or superfluous features potentially contribute to opportunities for misclassification. Further, the added computation power required by each additional feature leads to overall performance degradation. This phenomenon affects classical systems as well as neural networks.

There are numerous approaches available for reducing the number of features in a given candidate feature set. For example, if a feature is a linear combination of the other features, then that feature may be eliminated from the candidate feature set. If a feature is approximately independent of the classification, then it may be eliminated from the candidate feature set. Further, a feature may be eliminated if removal of that feature from the candidate feature set doesn't noticeably degrade the classifier performance, or degrade classifier performance beyond pre-established thresholds. As such, the feature process 104 interacts with the effectiveness process 112 to insure that an optimal, or at least measurably effective candidate feature set is derived.

If the effectiveness process 112 feeds back to the feature process 104 for a modification to the candidate feature set, the feature process 104 extracts a new set of feature vectors based upon the new candidate feature set. The training process 108 retrains the candidate classifiers using the new feature vectors, and the effectiveness process 112 computes a new performance measure based upon the retrained candidate classifier set.

The effectiveness process 112 may also feedback to the training process 108 so that an adjustment or adjustments to at least one candidate classifier can be implemented. Based upon the performance measure, a completely different candidate classifier algorithm may be selected, new candidate classifiers or classifier algorithms may be added, and one or more candidate classifiers may be removed from the candidate classifier set. Alternatively, a modification to one or more classifier parameters used to train a select one of the candidate classifiers may be implemented. Further, the manner in which a candidate classifier is trained may be modified. For example, a candidate classifier may be retrained using a subset of each extracted feature vector, or the candidate classifiers may be recomputed using a subset of the available candidate classifiers. Once the refining action has been implemented, the training process 108 re-computes the candidate classifiers, and the effectiveness process 112 calculates a new performance measure.

The feedback and retraining of the candidate classifiers continues until a predetermined stopping criterion is met. Such criteria may include for example, user intervention, the effectiveness process 112 may determine that no further adjustments are required, a predefined number of iterations may be reached, or other stopping acts are possible. For example, where the data set 102 is classified, or where the classification process is supervised, a figure of merit may be computed. The figure of merit is based upon an analysis of the outcome of the classifiers, including the preferred classifier or classifiers compared to the expert classified outcomes. The pattern recognition construction process 100 is thus iteratively run until the data set 102 is 100% successfully classified, or until the improvements to the candidate classifiers fail to improve statistically sufficiently. Upon completion, an optimal, or at least final feature set and optimal, or at least final classifier or classifier set are known. Further, the pattern recognition construction process 100 can preferably report to a user the features determined to be relevant, the confidence parameters of the classification and/or other similar information as more fully described herein.

For example, where a number of candidate classifiers are trained, a report may be generated that identifies performance measures for each candidate classifier. This report may be used to identify a final classifier from within the candidate classifiers in the classifier set, or to allow a user to select a final classifier. Alternatively, the pattern recognition construction process 100 may automatically select the candidate classifier by selecting for example, the classifier that performs the best relative to the other candidate classifiers.

The feature set and classifier established when the stopping criterion is met optionally defines the final feature set and classifier 114. The final feature set and classifier 114 are used to assign an unknown data object 116 to its predicted class. The unknown data object 116 is first introduced to a feature measure process, or feature extract process 118 to extract a feature vector. Next a classify process 120 attempts to identify the unknown data object 116 by classifying the measured feature o vector using the final classifier 114. The feature measure process 118 and the classify process 120 establish the requisite parameters from the final feature set and classifier 114 determined from the data set 102. For example, the output of the classify process 120 comprises the classified data set 122, and the classified data set 122 comprises the application data objects each with a predicted class.

It should be observed that the final feature set and classifier 114 are illustrated in FIG. 1 as coupled to the feature measure process 118 and the classify process 120 with dashed lines. This is meant to indicate that the feature measure process 118 and the classify process 120 may optionally be in a separate system from the remainder of the pattern recognition construction process 100. For example, the pattern recognition construction process 100 may output the final feature set and classifier 114. The final feature set and classifier 114 may then be installed for use in, or applied to other systems. Further, the feature measure process, or feature extract process 118 may be implemented as a separate module, or alternatively, it may be implemented within the feature process 104. Also, the classify process 120 may be an individual module, or alternatively implemented from within training process 108.

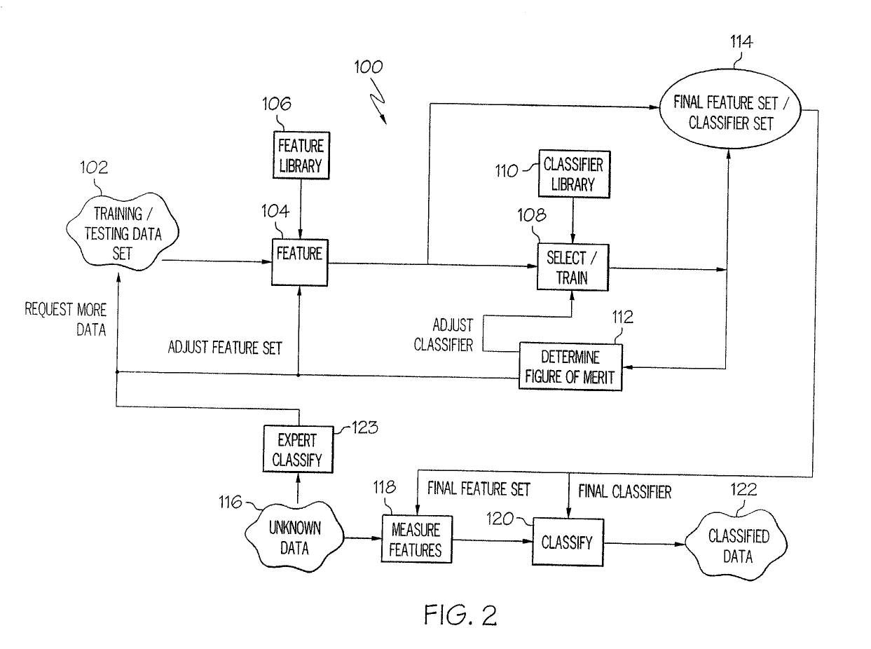

Referring to FIG. 2, the pattern recognition construction process 100 according to another embodiment of the present invention is similar to the pattern recognition construction process illustrated in FIG. 1. However, the final feature set and classifier 114 are coupled to the feature measure process 118 and the classify process 120 with solid lines. This indicates that the feature measure process 118 and the classify process 120 is integrated with the remainder of the pattern recognition construction process 100. The feature measure process 118 may be implemented as a separate process, or incorporated into the feature process 104. Likewise, the classify process 120 may be implemented as a separate process, or incorporated into the training process 108.

Also, a feedback path has been included from the unknown data object 116 to a determine classification module 123 to the data set 102. This feedback loop may be used to retrain the classifier where classify process 120 fails to properly classify the unknown data object 116. Essentially, upon determining a classification failure, the unknown data object 116 is properly classified by an external source. This could be for example, a human expert. Based upon the provided classification data, the unknown data object 116 is cycled through the feature process 104, the training process 108, and the effectiveness process 112 to ensure that the unknown data will be properly classified in the future. Accordingly, the label of final feature set and classifier 114 has been changed to reflect the feature set and classifier 114 are now the “current” feature set and classifier, subject to change due to the continued training.

Accordingly, the pattern recognition construction process 100 illustrated in FIG. 2 can continue to learn and train beyond the presentation of the initial training/testing data objects provided in the data set 102. For example, in certain industrial applications, the pattern recognition construction process 100 can adapt and train to accommodate new or unexpected variances in the data of interest. Likewise, old data that was used to train the initial classifier may be retired and the classifier retrained accordingly. It should be appreciated that the feedback of the unknown data object 116 to the feature process 104 via the determine classification process 123 includes not only continuous feedback for continued training, but may also include continued training during discrete periods. A software agent, a user, a predetermined intervallic event, or any other triggering event may determine the periods for continued training. Thus the periods in which the current feature set and classifier 114 may be updated can be controlled.

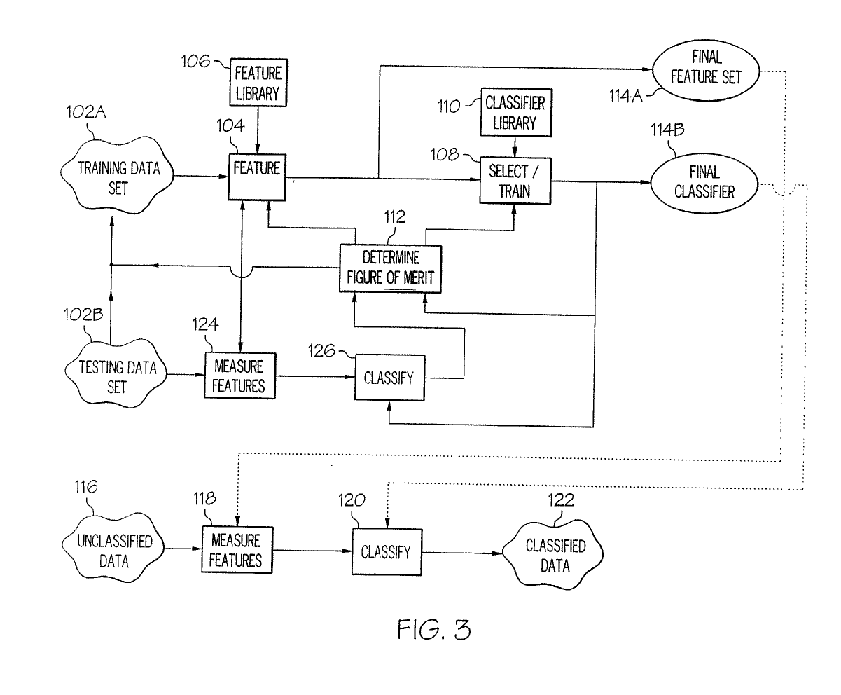

Another embodiment of the pattern recognition construction process 100 is shown in the block diagram of FIG. 3. As illustrated, the training and testing data objects of the data set 102 of FIG. 1 are broken into a training data set 102A and a testing data set 102B. In this embodiment of the present invention, it is preferable that both the training data set 102A and the testing data set 102B are classified prior to processing. The classification may be determined by a human expert, or based on other aspects of interest, including non-information measurements on the objects of interest. However this need not be the case as more fully explained herein. Basically, the training data set 102A is used to establish an initial candidate feature set as well as an initial candidate classifier or candidate classifier set. The testing data set 102B is presented to the pattern recognition construction process 100 to determine the accuracy and effectiveness of the candidate feature set and candidate classifier(s) to accurately classify the testing data objects.

For example, the pattern recognition construction process 100 may operate in two modes. A first mode is the training mode. During the training mode, the pattern recognition construction process 100 uses representative examples of the types of patterns to be encountered during recognition and/or testing modes of operation. Further, the pattern recognition construction process 100 utilizes the knowledge of the classifications to establish candidate classifiers. A second mode of operation is the recognition/testing mode. In the testing mode, the candidate feature set and candidate classifiers are tested, and optionally further refined using performance measures and feedback as described more thoroughly herein.

The feature process 104 initially operates on the training data set 102A to generate training feature vectors. The training feature vectors may be generated for example, using any of the techniques as set out more fully herein with reference to FIGS. 1 and 2. The training processing 108 selects and trains candidate classifiers based upon the training feature vectors generated by the feature process 104.

The effectiveness process 112 monitors the results and optionally, the progress of the training process 108, and determines performance measures for the candidate classifiers. Based upon the results of the performance measures, feedback is provided to the training data set 102A to indicate that additional feature vectors are required, the feature process 104 to modify the feature vectors, and the training process 108 as more fully explained herein. The feedback approach iteratively continues until a predetermined stopping criterion has been met. Upon completion of the iterative process, a feature set 114A and a classifier or classifier set 114B result.

Next, the effectiveness of the feature set 114A and the classifier 114B are measured by subjecting the feature set 114A and the classifier or classifier set 114B to the testing data set 102B. A feature measure process or feature extract process 124 is used to extract testing feature vectors from the testing data set 102B based upon the feature set 114A. The feature extract process 124 may be implemented as a separate process, or implemented as part of the feature process 104. The classifier process 126 classifies training feature vectors based upon the classifier or classifier set 114B, and the effectiveness process 112 evaluates the outcome of the classifier process 126. The classifier process 126 may be implemented as a separate process, or as part of the training process 108.

Where the classifier process 126 fails to produce satisfactory classification results, the effectiveness process 112 may provide feedback to the training data set 102A to obtain additional training data, to the feature process 104 to modify the feature set, or to the training process 108 to modify the candidate classifiers. This process repeats in an iterative fashion until a stopping condition is met.

Once the training and testing data sets 102A, 102B have been suitably processed, then the unclassified or unknown data object 116 can be classified substantially as described above. For example, the feature measure process 118 and the classify process 120 are coupled to the final feature set and final classifier 114A,B with dashed lines. As with FIG. 1, this is meant to indicate that the feature measure process 118 and the classify process 120 may optionally be in a separate system from the remainder of the pattern recognition construction process 100.

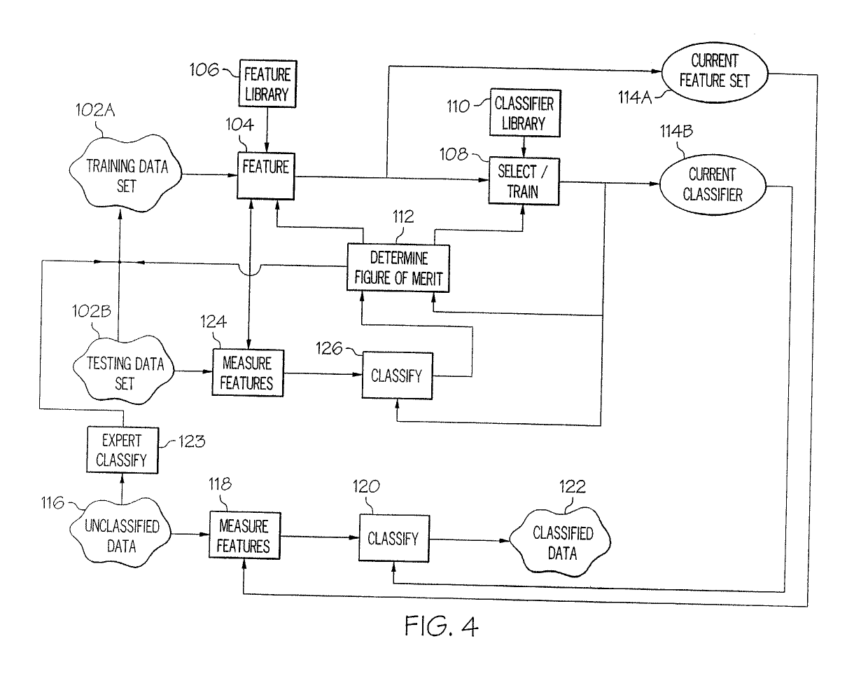

Referring to FIG. 4, the pattern recognition construction process 100 is similar to the pattern recognition construction process illustrated in FIG. 3 except that the dashed lines to the feature measure process 118 and the classify process 120 have been replaced with solid lines to indicate that the feature measure process 118 and the classify process 120 may be integrated into a single, coupled system with the remainder of the pattern recognition construction process 100. Accordingly, the labels of final feature set 114A and final classifier 114B of FIG. 3 have been changed to reflect the feature set and classifier 114A, 114B are now the “current” feature set and classifier, subject to change due to the continued training.

Further, an additional feedback path is provided from the unknown data object 116 to a determine classification module 123 to the training data set 102A. This feedback loop may be used to retrain the classifier where classify process 120 fails to properly classify the unknown data object 116. This additional feedback provides additional functionality for certain applications as explained more fully herein. Under this arrangement, the pattern recognition construction process 100 can continue to learn and train beyond the presentation of the training data set 102A and a testing data set 102B as described above with reference to FIG. 3.

It should be observed that certain applications make it impractical to implement a pattern recognition system capable of continued training as illustrated in FIGS. 2 and 4. For example, in certain medical applications, regulatory practice may prohibit the alteration of modification of a feature set or classifier after approval. In other applications, it may be impractical to include the additional feedback due to constraints of processing power, space, or time of operation. However, where the environment and other factors allow the implementation of the additional feedback path, for example, in certain industrial applications, the pattern recognition construction process 100 can adapt and retrain to provide robust and ongoing solutions to applications at issue. Such applications may include, but are not limited to surface defect inspection, parts identification, and quality control.

The pattern recognition construction process 100 can be embodied in any number of forms. For example, the pattern recognition construction process 100 may be embodied as a system, a computer based platform, or provided as software code for execution on a general-purpose computer. As software or computer code, the embodiments of the present invention may be stored on any computer readable fixed storage medium, and can also be distributed on any computer readable carrier, or portable media including disks, drives, optical devices, tapes, and compact disks.

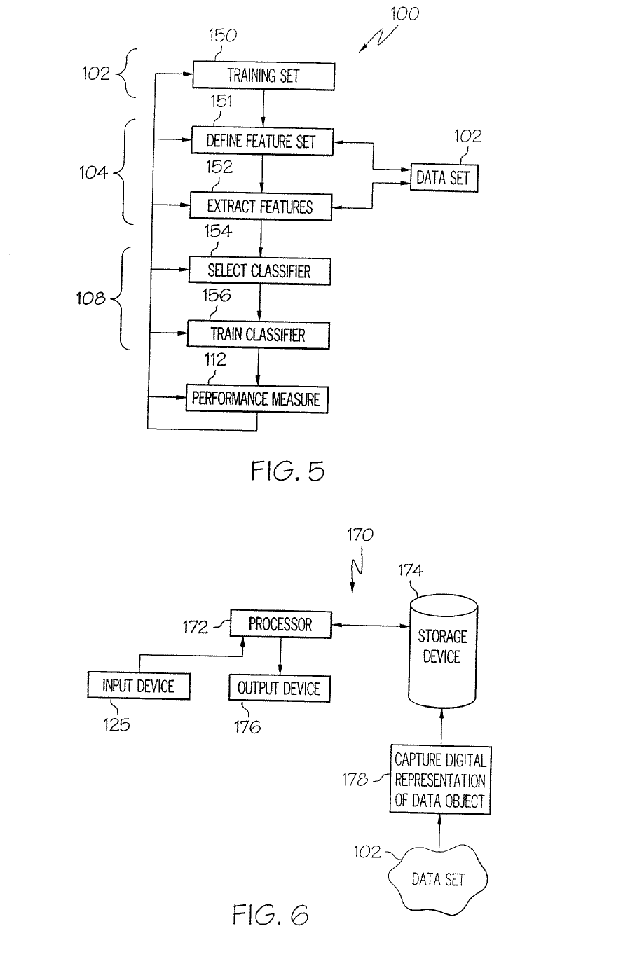

FIG. 5 illustrates the pattern recognition construction process or system 100 according to yet another embodiment of the present invention as a flow diagram. If pre-classified data does not exist, or if an existing training data set requires processing, modification, or refinement, a training set of data is processed at 150. The training data set may be generated for example, using the segmentation process discussed more fully herein with reference to FIGS. 20A-20E. Processing at 150 may be used to generate an entire set of classified data objects, or provide additional training data, such as where the initial training set is insufficient. The process at 150 may also be used to refine the feature set by removing particular data objects that are no longer suitable for processing as testing data.

As illustrated, the feature process or module 104 may optionally be provided as two separate modules including a feature select module or process 151 arranged to generate the candidate feature set through either automated or user guided input, and a feature extraction process or module 152 arranged to extract feature vectors from the data set 102 based upon the candidate feature set. In an analogous fashion, the training process 108 may be implemented as a training module including optionally, a separate classifier selection module 154 arranged to select or deselect classifier algorithms, and a classifier training process or module 156 adapted to train the classifiers selected by the classifier selection module 154 with the feature vectors extracted by the feature process 104.

The pattern recognition construction system may also be embodied in a turnkey system, including any combination of dedicated hardware and software. The pattern recognition construction process 100 is preferably embodied however, on an integrated computer platform. For example, the pattern recognition construction process 100 may be implemented as software executable on a computer, over a network, or across a cluster of computers. The pattern recognition construction process 100 may be deployed in a Web based environment, within a distributed productivity environment, or other computer based solution.

As a software solution, the pattern recognition construction process 100 can be programmed for example, as one or more computer software modules executable on the same or different computers, so long as the modules are integrated. Accordingly, the term module as used herein is meant only to differentiate the portions of the computer code for carrying out the various processes described herein. Any computer platform may be used to implement the various embodiments of the present invention. For example, referring to FIG. 6, a computer or computer network 170 comprises a processor 172, a storage device 174, at least one input device 175, at least one output device 176 and software containing an implementation of at least one embodiment of the present invention. The output device 176 is used to output the final feature set and classifiers, as well as optionally, outputting reports of performance metrics during training and testing. The system may also optionally include a digital capturing process or system 178 to convert the data set, or a portion thereof into a form of data accessible by the processor 172. This may include for example, scanning devices, analog to digital converters, and digitizers.

Preferably, the computers are integrated such that the flow of processing in the pattern recognition construction process 100 is automated. For example, according to one embodiment of the present invention, the pattern recognition construction process 100 provides automatic, directed feedback from the effectiveness process 112 to the feature process 104 and the training process 108 such that little to no human intervention is required to refine a candidate feature set and/or candidate classifier. Where human intervention is required or preferred, one main advantage of the present invention is that non-experts as may accomplish any human interaction explained more fully herein.

Irrespective of whether the candidate feature set is determined by a user, a software agent, or some other automatic algorithm or process, the same candidate feature set is preferably used to extract feature vectors across the entire data set when training or testing a classifier. Preferably, the feature process 104 extracts feature vectors across the entire data set 102. However, the feature process 104 may batch processes the data set 102 in sections, or process data objects individually before the training processing 108 is initiated. Further, the feature process 104 need not have extracted every possible feature vector from the data set 102 before the training process 108 is initiated. Accordingly, the training data may be processed all at once, in subsets or one data object at a time.

The applications and methods discussed below may each be incorporated as stand-alone approaches to data analysis, and are further applicable in implementing, at least portions of the pattern recognition construction process 100 described above with reference to FIGS. 1-6.

### Guided And Automatic Feature Set Generation

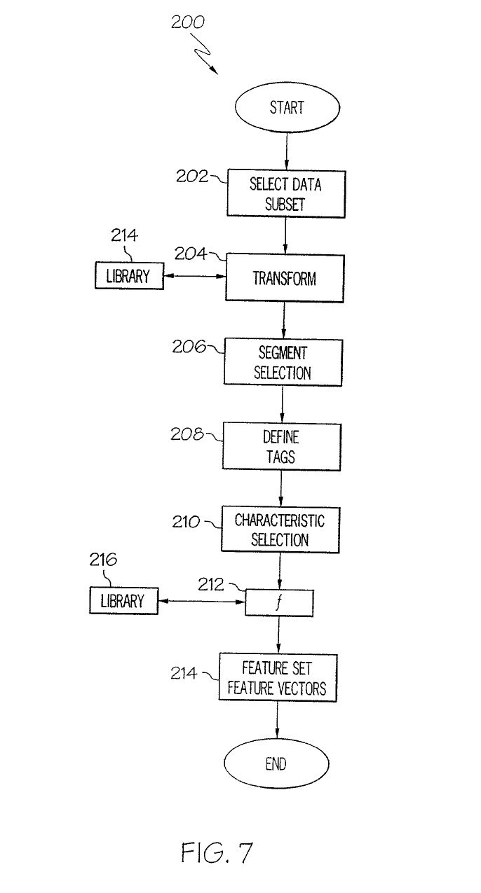

In certain applications, it is desirable to obtain user interaction for the selection of features. Referring to FIG. 7, a feature set generation process 200 is illustrated where a feature set is created or modified at least in part, by user interaction. The feature set generation process 200 allows experts and non-experts alike to construct feature sets for data objects being analyzed. Advantageously, the user interacting with the feature set generation process 200 need not have any expertise or specialized knowledge in the area of feature selection. In fact, the user does not need expertise or specialized knowledge in the field to which the data set of interest pertains. Further, where the feature set generation process 200 is implemented as a computer program, the user does not require experience in software code writing, or in algorithm/feature set software encoding. It should be appreciated that the feature set generation process 200 may be incorporated into the feature process 104 of FIGS. 1-5, may be used as a stand-alone method/process, or may be implemented as part of other, processes and applications.

The feature set generation process 200 is implemented on a subset 202 of the data of interest. The subset 202 to be explored may be selected by a human user, an expert, or other selection process including for example, an automated or computer process. The subset 202 may be obtained from a current data set or from a different (related or unrelated) data set otherwise accessible by the feature set generation process 200. Further, when building a feature set, select features may be derived from both the current and additional data sets.

The subset 202 may be any subset of the data set including for example, a group of data objects or the entire data set, a particular data object, a part of a data object, or a summary of the data set. Where the subset 202 is a summary of the data set, the summary may be determined by the user, an expert, or from any other source.

Initially, the subset 202 may be processed into a transformed subset 204 to bring out or accentuate particular features or aspects of interest. For example, the transformed subset 204 may be processed by sharpening, softening, equalization, resizing, converting to grayscale, performing null transformations, or by performing other known processing techniques. It should be appreciated that in some circumstances, no transformation is required. Next, segments of interest 206 are selected. The user, an automated process, or the combination of user and automated process may select the segments of interest 206 from the subset 202, or transformed subset 204.

The selected segments of interest 206 are provided with tags or tag definitions 208. Tags 208 allow the segments of interest 206 to be labeled with some categories or numbers. The tags may be generated automatically, or by the expert or non-expert user. Optionally, characteristics 210 of the segments of interest 206 are identified. For example, characteristics 210 may include identifying two or more segments of interest 206 as similar, distinct, dissimilar, included, excluded, different, identical, mutually exclusive, related, unrelated, or the segments should be ignored. The term “characteristics” is to be interpreted broadly and is used herein interchangeably with the terms “relationships”, “conditions”, “rules”, and “similarity measures” to identify forms of association or disassociation where comparing or otherwise analyzing data and data segments. A user, automated process, or combination thereof may establish the characteristic. For example, the feature set generation process 200 may provide default characteristics such as all segments are similar, different, related, unrelated, or any other relation, and allow a user to optionally modify the default characteristic.

Based upon the segments of interest 206 selected, and optionally, the tag definitions 208, and characteristics 210, a candidate transformation function 212 is computed. The candidate transformation function 212 is used to derive a feature, features, or a feature set. Once the candidate transformation function has been computed, the user may continue to build additional features and feature sets. Further, additional regions of interest can be evaluated in light of the outcomes of previous analysis. For example, the resulting new features can then be evaluated to determine whether they contribute significantly to improvements or changes in the outcomes of the analysis. Also, the user may start over building a new feature set.

To enhance functionality of the feature set generation process 200, a library of algorithms may be provided. For example, a data transformation library 216 may be used to provide access to transform algorithms. Further, a function library 218 may be used to provide algorithms for performing the candidate transformation function 212. It is further preferable that the optional data transformation library 216 and function library 218 are extensible such that new aspects and computational algorithms may be added, and existing algorithms modified and removed.

It should be appreciated that the results generated by the feature set generation process 200 are pluggable, meaning that the output, results of processing, including for example, the creation of features, feature sets, and signatures may be dropped to, or otherwise stored to disks or other storage devices, or the results may be passed to other processes either directly or indirectly. Further, the output may be used by, or shared with other applications. For example, once the feature set has been established, feature vectors 214 may be computed across the entire data set. The feature vectors may then be made available for signature analysis/classification, clustering, summarization and other processing. Further, the feature set generation process 200 may be implemented as a module, part, or component of a larger application.

Referring to FIG. 8, a block diagram illustrates a computer-based implementation of the feature set generation process 200. A data set 250 comprising a plurality of digitally stored representations of images is provided for user-guided analysis. The images in the data set 250 are preferably represented as digital objects, or in some format easily readable by the computer system. For example, the data set may o comprise digital representations of images converted from paper or film and saved to a storage medium accessible by the computer system. This allows the feature set generation process 200 to operate on different representations of the image data, such as a collection of images in a directory, a database or multiple databases containing the images, frames in a video object, images on pages of a web site, or an HTML hyperlink or web address pointing to pages that contain the data sets.

A first operation 252 identifies an image subset 254 of the data set. The first operation 252 can generate the subset 254 through user interaction or an automated process. For example, in addition to user selection, software agents, the software itself, and other artificial processes may be used to select the subset 202.

An optional second operation 256 is used to selectively process the image subset 254 to bring out particular aspects of interest to produce a transformed image subset 258. As used herein, the phrase “selectively process” includes an optional processing step that is not required to practice the present invention. Although no processing is required, it is possible to implement more than one process to transform the image subset 258. As pointed out above, any known processing techniques can be used including for example, sharpening, softening, equalization, shrinking, converting to grayscale, and performing null transformations.

A third operation 260 is used to select segments of interest. The third operation 260 comprises a user-guided segment selection operation 262 and/or an algorithm or otherwise automated segment selection operation 264. Preferably, the third operation 260 allows a segment of interest to be selected by a combination of the user-guided segment selection operation 262 and the automated segment selection operation 264. For example, the automated segment selection operation 264 may select key or otherwise representative regions based upon an analysis of the image subset 254, or transformed image subset 258. A user may select the segments of interest 206, by selecting, dragging out, or otherwise drawing the segments of interest 206 with a draw tool within software. Further, a mouse, pointer, digitizer or any other known input/output device may be used to select the segments of interest 206. Further, the segments of interest 206 may be determined from “pre-tiled” versions of the data. Yet further, the computer, a software agent, or other automated process can select segments of interest 206, based upon an analysis of the subset 202, or the transformed subset 204.

A fourth operation 266 provides tags. The tags may be user-entered 268, automatically generated 270, or established by a combination of automated and user-entered operations. Optionally, a fifth operation 272 selectively provides characteristics of the segments to be assigned. Similar to the manner described above, the phrase “selectively provides” is meant to include an optional process, thus no characteristics need be identified. Further, any number of characteristics may optionally be assigned. Similar to the other operations herein, the fifth operation 272 may include a user-guided characteristic operation 274, an automatic characteristic operation 276 or a combination of both. For example, the automatic characteristic operation 276 may assign by default, a condition that segments are similar, should be treated equally, differently, etc. A user can then utilize the user-guided characteristic operation 274 to modify the default characteristics of the segments by changing the characteristic to some other condition.

A sixth operation 278 utilizes the regions of interest, and optionally the tagging, to form a candidate segment transformation function and create features. A seventh operation 280 makes the results of the sixth operation 278, including signatures and features available for analysis. This can be accomplished by outputting the features or feature set to an output. For example, the feature set may be written to a hard drive or other storage device for use by other processes. Where the feature set generation process 200 is implemented a software module, the results are optionally pluggable referring to the fact that the features may be used in various data analytic activities, including for example, classification, summarization, and clustering.

The Directed Dynamic Analysis

Another embodiment of the present invention directed to developing a robust feature set can be implemented by a directed dynamic data analysis tool that obtains data input by a user or system agent at the object level without concern over the construction of signatures or feature sets. The term “dynamic analysis” of data as used herein means the ability of a user to interact with data such that different data items may be manipulated directly by the user. Preferably, the dynamic analysis provides a means for the identification, creation, analysis, and exploration of relevant features by users including data analysis experts and non-experts alike.

According to this embodiment of the present invention, the user/system agent does not have to understand or know particular signatures, classifications or even understand how to select the most appropriate features or feature sets to analyze the data. Rather, simple object level comparisons drive the analysis. Comparisons between data including data objects and segments of data objects are described in terms relationships, i.e. characteristics. For example, a relationship may declare objects as similar, different, not related, or other broad declarations of association or disassociation. The associations and disassociations declared by the user are then applied across an entire data set or data subset. For example, the translation may be accomplished by constructing a re-weighting or rotation of the original features. The re-weighting or rotation is then applied across the entire data set or data subset. It should be appreciated that the directed dynamic analysis may be incorporated into the feature process 104 of FIGS. 1-5, may be used as a stand-alone apparatus, method or process, or may be implemented as a part, component, or module within other processes and applications.

This embodiment of the present invention provides a platform upon which the exploratory analysis of diverse data objects is possible. Basically, diverse common measurements are taken on the data set, and then the measurements are combined into a signature, that may then be used to cluster and summarize the collection. User input is used to change or guide the analysis of the data objects. It should be observed that feature weights and combinations may be created that are commensurate with the user's assessments. For example, user input may be used to change or guide views and summaries of the data objects. Thus, if a user provides guidance that some subset of the data set is similar, the view of the entire data set changes to reflect the user input. Basically, according to one embodiment of the present invention, the user assessments are mapped back onto relative weights of the features.

One approach to this embodiment of the present invention is to turn the users guidance, along with the given features, into an extrapolatable assessment of the given features, and then apply the extrapolation. The extrapolation may be applied across the entire data set, or may have a local effect. There are many different ways to implement this approach. One implementation is based upon Canonical Correlations Analysis. User input is coded and the resulting rotation matrices are used to construct new views of the data.

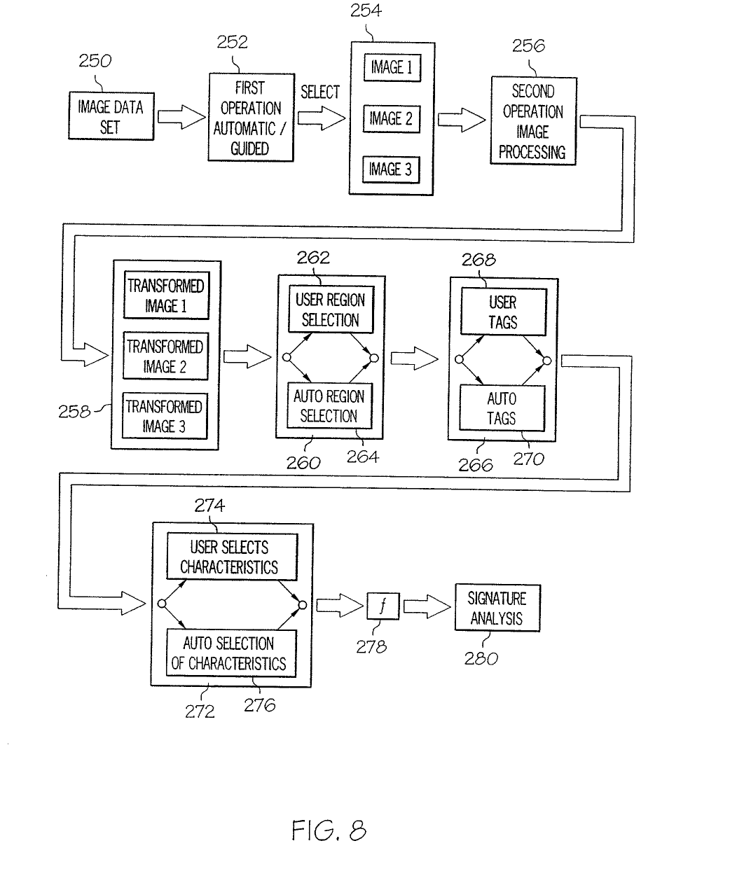

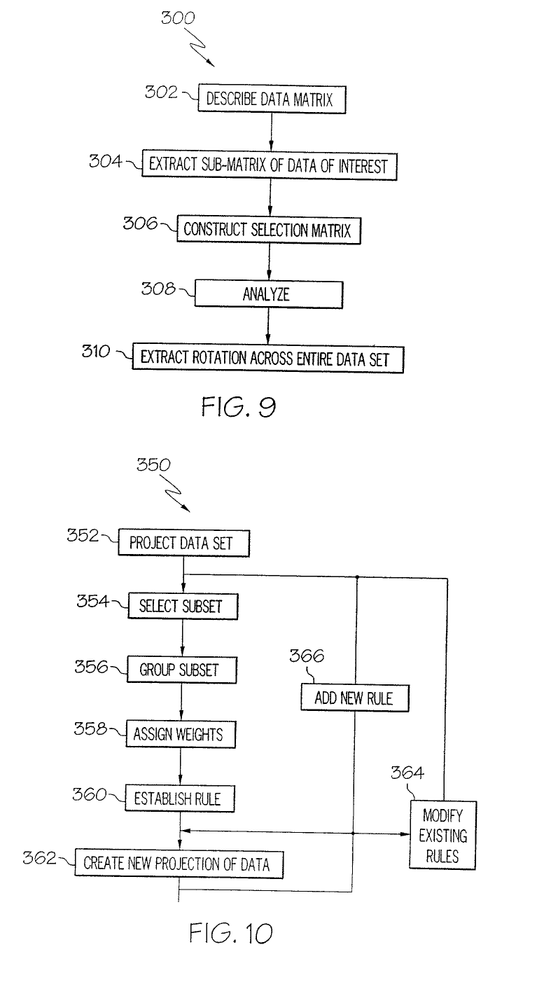

Referring to FIG. 9, the dynamic data analysis approach 300, is derived as follows. A data matrix 302 is constructed of the form:

$${A}_{n \times m} = [ \begin{matrix}{a}_{11} & {a}_{12} & ⋯ & {a}_{1 m} \\ {a}_{21} & {a}_{22} & ⋯ & {a}_{2 m} \\ ⋮ & ⋮ & ⋮ & ⋮ \\ {a}_{n1} & {a}_{n2} & ⋯ & {a}_{n m}\end{matrix} ]$$

where αᵢⱼ∈R and aᵢⱼ=λⱼ (Oⱼ) is the j^{th} measurement on the i^{th} object. A user determines similarity or dissimilarity of objects in the data matrix 302 (Aₙₓₘ,) and extracts a sub-matrix 304 that consists of the rows from the data matrix 302 corresponding to the desired objects. For example, a user may decide that objects 1 and 200 are similar, but different from object 50. Object 1001 is also different from objects 1 and 200. Further, objects 50 and 1001 are different. The sub-matrix is then constructed as:

$${A}_{subset} = [ \begin{matrix}{a}_{1 , 1} & {a}_{1 , 2} & ⋯ & {a}_{1 , m} \\ {a}_{200 , 1} & {a}_{200 , 2} & ⋯ & {a}_{200 , m} \\ {a}_{50 , 1} & {a}_{50 , 2} & ⋯ & {a}_{50 , m} \\ {a}_{1001 , 1} & {a}_{1001 , 2} & ⋯ & {a}_{1001 , m}\end{matrix} ]$$

It should be observed that the construction of the sub-matrix 304 (A_{subset}) need not preserve the precise relative row positions for the extracted object rows from the data matrix 302 (Aₙₓₘ). In the current example, object 200 has taken the second row position and object 50 is seated in the third row position.

A selection matrix 306 is then constructed. The selection matrix 306 describes the relation choices established by the user. The selection matrix 306 has the same number of rows as the extracted sub-matrix 304 (A_{subset}). The columns correspond to the established “rules”. Thus the selection matrix 306 has a number of columns corresponding to the number of conditions established by the user. Following through with the above example, three conditions were established. That is, objects 1 and 200 are similar, objects 50 and 1001 are different from objects 1 and 200, and objects 50 and 1001 are different. While any values may be assigned to represent similarity and difference, it is convenient to represent similarity with a one's digit and dissimilarity with a zero digit. Using this designation, the selection matrix 306 from the current example, and based upon the construction of the extracted sub-matrix 304 (A_{subset}) is constructed as:

$${A}_{selection} = [ \begin{matrix}100 \\ 100 \\ 010 \\ 001\end{matrix} ]$$

It should be observed that the two dissimilarity conditions result in multiple columns, each column separating the object of interest.

Once the data matrix 302, extracted sub-matrix 304 and selection matrix 306 have been established, a canonical correlations procedure 308 is applied to the matrices. The rotations obtained from canonical correlation are applied across the entire data set, or a subset of the data to create a visual clustering that reflects the users similarity and dissimilarity choices 310.

The dynamic data analysis approach 300 can be embodied in a computer application such that the rich graphic representations allowed by modern computers can be used to thoroughly exploit the dynamic nature of this approach.

Referring to FIG. 10, a flow chart illustrates a computer implemented dynamic data analysis 350 according to one embodiment of the present invention. Initially, the computer implemented dynamic data analysis 350 is initiated and processing begins by identifying and projecting a data set 352. From the data set 352, a subset of data 354 is selected. The subset of data 354 is grouped 356 and preferably assigned weights 358 to establish a rule 360. A rule 360 is defined as the combination of a group 356 along with their optionally assigned weights 358. The rule 360 establishes the relationship to the objects in the group (similar/dissimilar etc.) and the weight of that relationship. For example, the weight 358 may define a group 356 as strongly similar or loosely similar.

Once a rule 360 is established, a new projection of the data may be generated 362, whereby the rule(s) are applied across the data set. Alternatively, existing rules may be deleted or modified 364. For example, a rule may be enabled or disabled determining whether they are included in the calculations for a new projection. Further, the assigned weights associated with groups of data may be changed. Further, new rules may be added 366. Once a new projection of the data is generated 362, the user can continue to modify rules 364, or add new rules 366. Alternatively, the user may opt to start the data analysis over by selecting a new data set or by returning to the same data set. It should be appreciated that any of the software tools and techniques as described more fully herein may be applied to the computer implemented dynamic data analysis 350.

### The Dynamic Analysis Tool

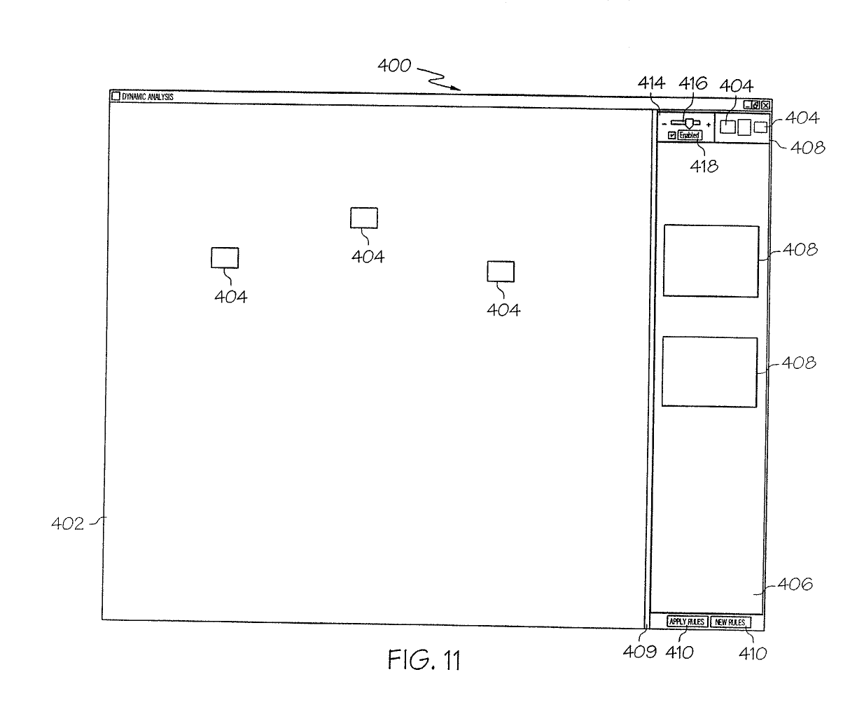

FIGS. 11-13 illustrate an example of one embodiment of the present invention, wherein a computer approach to dynamic data analysis is implemented. The dynamic analysis tool 400 incorporates user (or other) input at the object (as opposed to the signature) level to change or guide the views and summaries of data objects. As illustrated, the dynamic analysis tool 400 is applied to analyze images. However, it should be appreciated that any data may be dynamically studied with this software.

Briefly, a data set such as a collection of images is loaded into a workspace. A user interactively indicates group memberships or group distinctions for data objects such as images. The groups are used to define at least one rule. The rule establishes that, for the selected group or subset of data, the objects are similar, dissimilar, or other broad generalization across the group. A weight is also assigned to the group. The view of the entire collection of objects may then be updated to reflect that existing rules. Essentially, the groups represent choices as categories or “key words”. The computer then calculates a mapping between the user provided category space, then updates the view of the images in a workspace. The user may continue to process the data as described above, that is by selecting groups, identifying further similarities/differences, assigning weights and applying the new rule set across the data. By modifying the rules, a user may narrow or further distinguish a subset of data, broaden a subset of data to expand search, start over, or dynamically perform any number of additional activities. The software implements the embodiment described previously, preferably having its fundamental algorithm based upon the Canonical Correlations analysis and using the resulting rotation matrices from the calculations to create new views of the entire data set as more fully described herein.

When started, the software creates a window that is split vertically into two view panes. The projection view 402, illustrated as the left pane, is the workspace or view onto which data objects 404 are projected according to some predetermined projection algorithm. The rule view 406, illustrated as the right pane, consists of one or more rule panes 408. The window displaying the entire dynamic analysis tool 400 may be expanded or contracted or the divider 409 between the projection view 402 and the rule view 406 may be moved right or left to resize the panes as is commonly known in the art.

Referring to FIG. 11, the projection view 402 allows a user to visualize the data objects 404 projected thereon. It should be observed that the data objects 404 displayed in the projection view 402 may comprise an entire data set, a subset of a larger data set, may be a representation of other, or additional data, or particular data selected from a set. Further, the projection view 402 allows the user to interact with the projected data objects 404. Data objects 404 are displayed in the projection view 402 at coordinates calculated by an initial projection algorithm according to attributes and features of the particular data type being analyzed. Data objects 404 may be displayed in their native form (such as images) or depicted by icons, glyphs, points or any other representations.

The rule view 406 initially contains one empty rule pane 408. Rule panes 408 are stacked vertically in the rule view 406 as rules are added. A rule is selected for editing, adding or removing data objects 404 that define the rule, by clicking anywhere on the rule pane 408 containing the rule to be edited. Buttons 410 are used to apply the rules and to add a new rule pane 408. As illustrated, two buttons 410 appear at the bottom of the rule view 406. However, any number of buttons may be used. Further, the buttons 410 may be placed anywhere as desired. Further, while described as buttons, it will be appreciated that any method may be used to receive the user input including but not limited to buttons, drop down boxes, check boxes, command line prompts and radio buttons.

The rule pane 408 encapsulates a rule, which is defined by two or more data objects 404 and a weight value. As illustrated, data objects intended to define a rule are placed in a rule data display 412. Icons such as thumbnails are preferably used to represent data objects 404 in the rule data display 412. However, any representation may be used. If there are more representations of data objects 404 that can fit in the display area of the rule data display 412, a scroll bar may be attached to the right side of the rule data display 412 so that all representations may be viewed by scrolling through the display area. The weight value 416 may comprise one or more of any number of characteristics as discussed more thoroughly herein.

A rule control area 414 is positioned to the left of the rule data display 412 as illustrated. The rule control area 414 provides an area for a user to select a weight value 416 associated with the selected data objects 404. The weight value 416 may be implemented as a slider, a command box, scale, percentile or any other representation. The weight value 416 determines the degree of attraction that is to exist between the data objects 404 shown in the rule data display 412. For example, in one implementation, a slider is used to combine similarity and dissimilarity. The farther right the slider is moved, the greater the degree of attraction between the data objects contained in the rule. The farther to the left the slider is moved, the greater the degree of repulsion or dissimilarity between the data objects contained in the rule. The center position is neutral. Alternatively, a slider in combination with a similar/dissimilar checkbox or other combination may be provided. Further, only the option of similarity may be provided. Under this scenario, the slider measures degrees of similarity. Similarly, other conditions or associations may be provided.

The rule control area 414 also provides a rule enable selection 418 that allows a user to enable or disable the particular rule. For example, the rule enable selection 418 may be implemented as a check box to enable or disable the rule. If a rule is enabled it is included with all other enabled rules when a new projection is created. If a rule is disabled the data icons in the rule display area along with the rule display area are grayed out reflecting the disabled state. Disabled rules are not included in the calculation of a new projection. It should be appreciated that the positions and representations of the rule data display 412 and the rule control area 414 can vary without departing from the spirit of this embodiment.

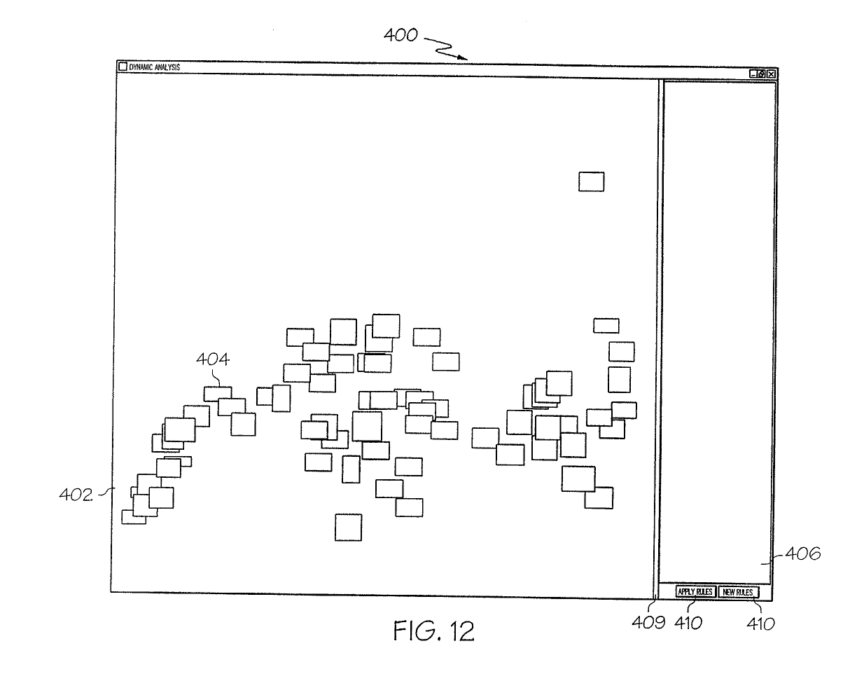

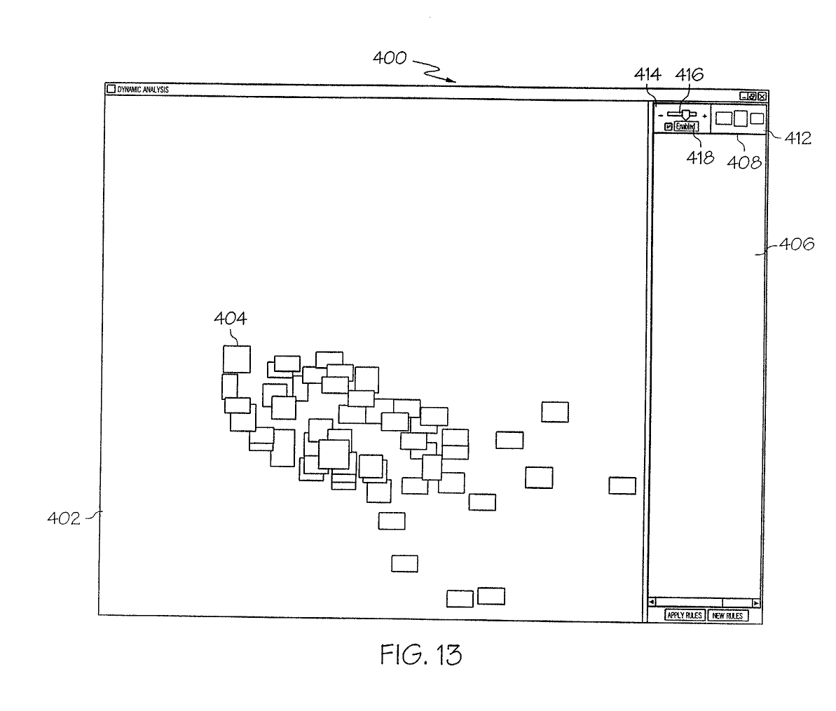

Referring to FIGS. 11 and 12, when the Dynamic Analysis Tool 400 is started, and the display view 402 is populated with data objects 404, an initial projection is displayed in the projection view 402, and a new, empty rule is added to the rule view 406. Referring to FIGS. 11 and 13, the user interacts with data objects 404 in the projection view 402 to build rules in the rule view 406. For example, interaction may be implemented by brushing (rolling over) or clicking on the data objects 404 using a computer input/output device such as a mouse, scroll ball, digitizing pen or any other input output device. The data objects 404 may optionally provide feedback to the user by providing some indicia or other representation, such as by changing the color of their backgrounds. For example, a green background may be displayed when brushed and a red background may be displayed when selected.

A user selects certain data objects 404 of interest to manually and dynamically manipulate how the entire set of data objects 404 in the projection view 402 are subsequently projected. This is accomplished by selecting into a rule pane 408, data objects 404 that the user would like to associate more closely. Data objects 404 are selected for example, by clicking on them, using a lasso tool to select them, or dragging a selection box to contain them. When data objects 404 are selected, their background turns red or, as in the case of point data, the point turns red and their representative icons appear in the rule data display area 412 of the currently active rule pane 408. If the user selects the background of the projection view 402, the data objects 404 in the currently active rule pane 408 are removed.

After selecting the data objects 404 for a particular rule, a weight value 416 is established. As illustrated, the weight value is implemented with a slider control. The weight establishes for example, the degree of attraction of the data objects 404 in the rule data display area 412. According to one embodiment of the present invention, the further right the slider is moved, the greater the degree of attraction between the data elements contained within the rule. After each rule is defined, the user may add new rules, such as by clicking or otherwise selecting one of the buttons 410 assigned to add new rules.

When the user selects a rule pane 408, for example by clicking with a pointing device inside the rule pane 408, a visual representation that the rule pane 408 has become active is presented. This may be accomplished by changing the appearance of the selected rule pane 408 to reflect its active state. Preferably, the data objects 404 represented in the rule pane 408 are highlighted or otherwise shown as selected in the projection view 402.

Once active, the user may be allowed to edit and delete a rule. For example, if the user right-clicks the mouse or other pointer over a rule, a context menu with at least two choices pops up. A first menu item may clear (remove the current data objects 404) from the rule. A second menu item may delete the rule all together. Further, any aspects of the rule may be edited. For example, the data objects 404 of interest that were originally added to the rule may be edited in the rule data display 412. The weight value 416 may be changed or otherwise adjusted, and the rule may be selectively enabled or disabled using the rule enable selection 418. A disabled rule is preferably grayed out reflecting a disabled state. Other indicia may also be used to signify that the rule will not be considered in a subsequent projection until it is re-enabled.

A new projection is calculated and displayed in the projection view 402 based upon a user command, such as by selecting or clicking on one of the buttons 410 assigned to apply the rules. Several rules may be defined before submitting them using the apply rules function assigned to one of the buttons 410. Further, the rules may be repeatedly edited prior to projecting a new view. According to one embodiment of the present invention, all enabled rules are included when computing a new projection. Also, all empty rules are preferably ignored during the calculation of a new projection.

It should be observed that the process described herein is repeated as desired. Upon completion of the analysis, the results may be made pluggable, or available to other applications, modules, or components of a larger application for further processing. For example, the Dynamic Analysis Tool 400 may be used to select features as part of the feature process 104 discussed with reference to FIGS. 1-5.

### Calculating Features From A Collection of Data Objects

The extraction of a feature set from the data of interest is an important step in classification and data analysis. One aspect of the present invention includes methods to estimate fundamental data characteristics without having to engage in labor-intensive construction of recognizers for complex organized objects or depend upon a priori transformations. The fundamental approach is to evaluate data objects against a standard list of primitives, and utilize clustering, artificial neural networks and/or other classification algorithms on the primitives to weigh the features appropriately, construct signatures, and perform other analysis.

Utilizing this method, features are calculated in batch form, and the signatures are based upon the entire data set being analyzed. It should be appreciated that this approach can be embodied in a stand-alone implementation, or can be embodied as a part of a larger feature selection or extraction process or system, including for example, those feature selection aspects of the present invention described herein with reference to FIGS. 1-13. For example, this approach can be used to in the derivation of the candidate segment transformation function 212 in FIG. 7, or in the sixth operation 272 to derive the candidate segment transformation function 212.

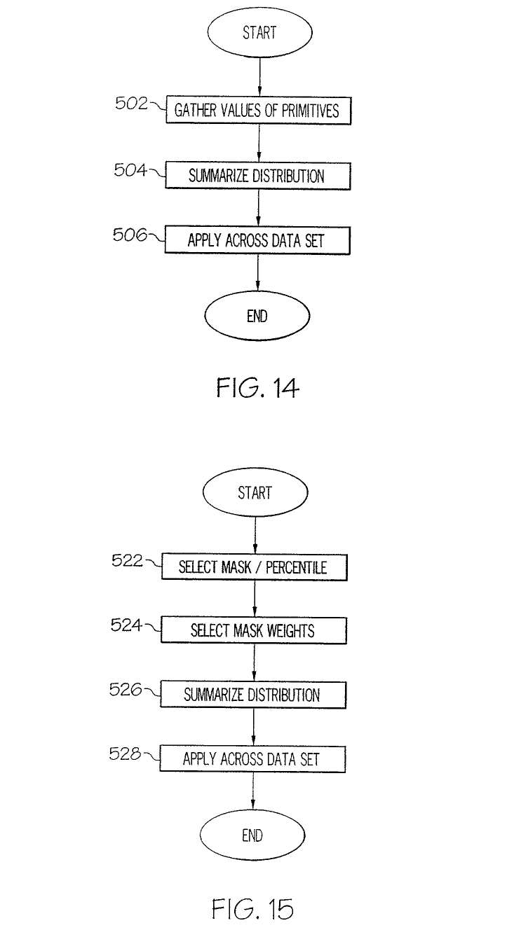

As shown in FIG. 14, a method for calculating features from a collection of data 500 is described. This method provides a robust approach that is applicable across any data set and presents considerable timesaving over other approaches by providing for example, a simple, organized structure to house the data. In other words, the structure acts something like a database. A user can obtain data objects upon request. Generally, the first step 502, is to gather up values of the various primitives from a data set being analyzed. In step 502, values of the primitives may be calculated locally on image segments, or on larger aspects of a data object or data set. For example, the primitives may be calculated across the segments of interest 206 in the feature set generation process 200 discussed with reference to FIG. 7, or the image subset 254 discussed with reference to FIG. 8. The primitives may be application specific, or may comprise more generally applicable primitives.

In step 504, the distribution of the values measured from the primitives is summarized, for example by using pre-determined percentiles. It should be appreciated that any other summarizing techniques may be implemented, e.g. moments, or parameters from distribution fits. In step 506, the summarized distribution is applied across the data set.

Several approaches may be taken when suggesting features from a data set. For example, as described above with respect to FIG. 14, the approach may be implemented by evaluating a standard list of primitives on the data in the collection of interest, and then using clustering, neural net, classification and/or other algorithms on these primitives to weight the features appropriately. From the result, a signature can be constructed. From this approach, a number extensions or enhancements are possible.

The flow chart of FIG. 15, describes a method similar to that described with reference to FIG. 14, except instead of using primitives, features are suggested from a data set by utilizing a choice of masks or percentiles. The mask size is selected in step 522. For the selected mask size from step 522, a mask weight is selected in step 524. The mask weight in step 524 may be associated with the constraint that the weights sum to zero, or alternatively, that the weights sum to some other value. For example, the constraint may be defined such that the weights sum to one. In step 526, the distribution of the values measured, is summarized.

The summarized distribution may embody any number of forms including for example, the use of a choice of percentiles, mean, variance, coefficient of variation, correlation, or a combination of the above may be used. In step 528, the summarized distribution is applied across the data set. For example, in the analysis of images, the mask size may be selected as a 3×3 matrix. Where an aspect of investigation is color, the 3×3 matrix is moved all around the image or images of interest. A histogram or other processing technique can then be used to extract color, spectral density or determine average color. This can then be incorporated into one or more features. It should be observed that the mask may be moved around either in an ordered or disordered manner. Further, the size of the mask can vary. The size will be determined by a number of factors including image resolution, processing capability etc. Further, it should be appreciated that the use of a mask is not limited to color determinations. Any feature can be detected such as the detection of edges, borders, local measurements and the like using this technique.

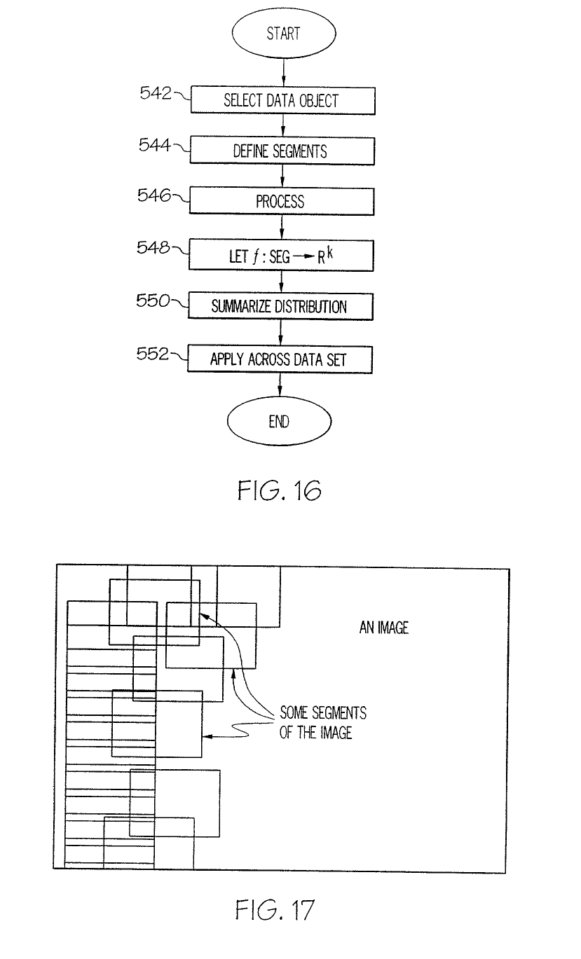

Yet another embodiment of the present invention that provides an alternative to the methods in FIGS. 14 andl5 is illustrated in FIG. 16. Data of interest is selected in step 542. The data of interest selected in step 542 is broken apart into subsections (sub-chunks) in step 544. The subsections 544 serve as the basis for a feature. The subsections may be rectangular, curvilinear, or any desired shape. Further, various subsections may overlap, or no overlap may occur. Additionally, the subsections may be processed in any number of ways in step 546. For example, the subsections may be normalized. A function is selected that maps a segment, a correlation, covariance or distance between two or more subsections to a vector in step 548. In step 550, the distribution of the values measured is summarized, and in step 552, the summarized distribution is applied across the data set or at least a data subset.

In mathematical terms, the deconstruction of the data of interest into subsections is expressed as:

$$I = {⋃}_{l ∈ Λ} {Seg}_{l} ,$$

where I is the data and Segₗ is a subsection of the data. FIG. 17 shows how this might look. Let f:Seg→R^{k} map a segment to a vector.

Under this arrangement, f may be defined in any number of ways. For example, assuming that the subsections are all the same size, the manner used to accomplish generating subsections of the same size will depend upon the type of data being analyzed. If the data were images for example, this could be accomplished by selecting the subsections to contain the same number of pixels. Under this arrangement, f expands the segment into the pixel gray values. This same approach can be used for a number of other processing techniques.

Alternatively, a function may be used that maps the subsection segment into predetermined features. Where each data object is broken into a single subsection, then this approach evaluates a standard set of primitives such as those described herein, against the subsection. Alternatively, the function whose components are some distances or correlations between Segₗ and other segments may be used. Under this approach, a feature is extracted from a subsection, then that feature is run across the data object and correlations are established. For example, where the data object is an image, the feature that is extracted from one subsection is compared to, or applied against some number of other subsections within the same image, or across any number of images. An ordered or disordered approach may be used. An example of an ordered approach is to run the extracted feature from subsection Segₗ top to bottom, left to right of the image from which Segₗ is generated, or across any number of other images.

Further, it should be appreciated that the above-described approaches are by way of illustration and not by way of limitation, of the flexibility of the present invention.

Further, any number of approaches may be combined. For example, Segₗ can be processed according to any number of primitives. Then, any number of additional subsections may be analyzed against the same collection of primitives. Additionally, distances correlations and other features may be extracted.

Once the subsections are transformed into a collection of vectors, the vectors are used to determine a signature. A numeric vector is used as the form of the signature, since the object signature will need to be subsequently used in classification systems. While there are numerous ways to determine a signature, one preferred method is to cluster the collection of vectors across all the data in the set, so that each data object can be extracted into a table. For example, where the data comprises images, the appropriate table may be a frequency table, indicating how many vectors for that image are in each cluster. Other tables or similar approaches may be used and will depend upon the type of data being analyzed. The generated table can form the basis for a signature that depends on the particular data set at hand. If the data set comprises images, and f expands the subsections into the pixel gray values for example, then the image features can be entirely created and based on the images at hand.

### Selection and Training of Classifiers

The selection and training of a classifier is a process designed to map out boundaries that define unique classes. Essentially, the feature space is partitioned into a plurality of subspace regions, each subspace region defining a particular class. The border of each class, or subspace region is sometimes referred to as a decision boundary. The classifier may then be used to perform classification. The idea behind classification is to assign a feature vector extracted from a data object to a particular, unique class.

This section describes a process for selecting and training classifiers, characterizations and quantifiers that may be incorporated or embodied in the training process 108 discussed herein with reference to FIGS. 1-6, may be used as a stand-alone process, or may be used in other applications or processes where classifiers or quantifiers are trained. It should be observed that classifiers, characterizations and quantifiers are related and referred to generally herein as classifiers. For example, where data objects being analyzed are numeric, it is more accurate semantically to refer to the trained data as quantified data.

The training of classifiers may be accomplished using either supervised or unsupervised techniques. That is, the training data objects used to construct a classifier may comprise pre-classified or unclassified data. It is, however, preferable that the data objects be pre-classified by some method. Where the classifier is trained using a supervised training technique, the system has some omniscient input to identify is the correct classification. This may be implemented by using an expert to classify the training images prior to the training process, or the classifications might be made based upon other aspects including non-data measurements of the objects of interest. Machine implemented techniques are also possible.

Alternatively, the training set may not be classified prior to training. Under these conditions, techniques such as clustering are used. For example, in one clustering approach, the training set is iteratively split and merged. Using a similarity measure, the training set is partitioned into distinct subsets. Subsets that are not unique are merged. This process continues until the subsets can no longer be split, or alternatively, some preprogrammed stopping criteria is met.

It is often desirable to train multiple candidate classifiers on a given training set. The optimal classifier may be selected from the multiple candidate classifiers by comparing some performance measure(s) of each classifier against one another, or by comparing performance measures of each candidate classifier against other established benchmarks. A comprehensive collection of candidate classifier methodologies, such as statistical, machine learning, and neural network approaches may all be explored for a particular application. Examples of some classification approaches that may be implemented include clustering, discriminant analysis (linear, polynomial, K-nearest neighbor), principal component analysis, recursive backwards error propagation (using artificial neural networks), exhaustive combination methods (ECM), single feature classification performance ordering (SFCPO), Fisher projection space (FPS), and other decision tree approaches. It should be appreciated that this list is not exhaustive of possible classification approaches and that any other classification techniques may be used.

The classifiers are optionally organized in a classifier library, such as the classifier library 110 discussed with reference to FIGS. 1-6. The classifier library may be extensible such that classifiers may be added or otherwise modified. Further, the classifier library may be used to select particular ones from a group of classifiers. For example, some classifiers are computationally intensive. Yet others exhibit superior classification abilities, but only in certain applications. Also, it may not be practical to process every known classifier for every application. By cataloging pertinent classifiers for particular applications, processing resources may be conserved.

### Refinement of Classifier Algorithms

Traditionally, improving the performance of a developed classifier requires considerable knowledge of classifier development methodologies as well as familiarity with the domain in which the classification problem exists. The present invention comprehends however, a software application that rapidly and intuitively accomplishes the refinement of classifier algorithms without requiring the software user to possess extensive domain knowledge. The software may be implemented as a stand-alone application, or may be integrated into other software systems. For example, the software may be implemented into the pattern recognition process 100 described with reference to FIGS. 1-6.

The approach attempts to identify complementary, application-specific features that supplement the classification and optimization of influential generic features. Such identification traditionally requires extended technical knowledge of a classifier's most influential features, especially for complex methodologies. Further, (often complex) links between the complete data object readily classified by expert review, and the extractable features necessary to automatically accomplish the classification must be appreciated.

Classifier refinement according to one embodiment of the present invention attempts to identify these complementary, application specific features without the need for a domain specific expert. The program receives as input, (such as data from another program, or module) data representing a broad range of candidate classifiers. The system is capable of producing outputs corresponding to each explored classifier, such as metrics of its performance including indications (i.e., weights) of which features influence the developed classifier. The present invention not only employs a host of candidate classifiers, but also understands the respective features that dictate their performance and infers refinements to the classifiers (or data prior to classification).

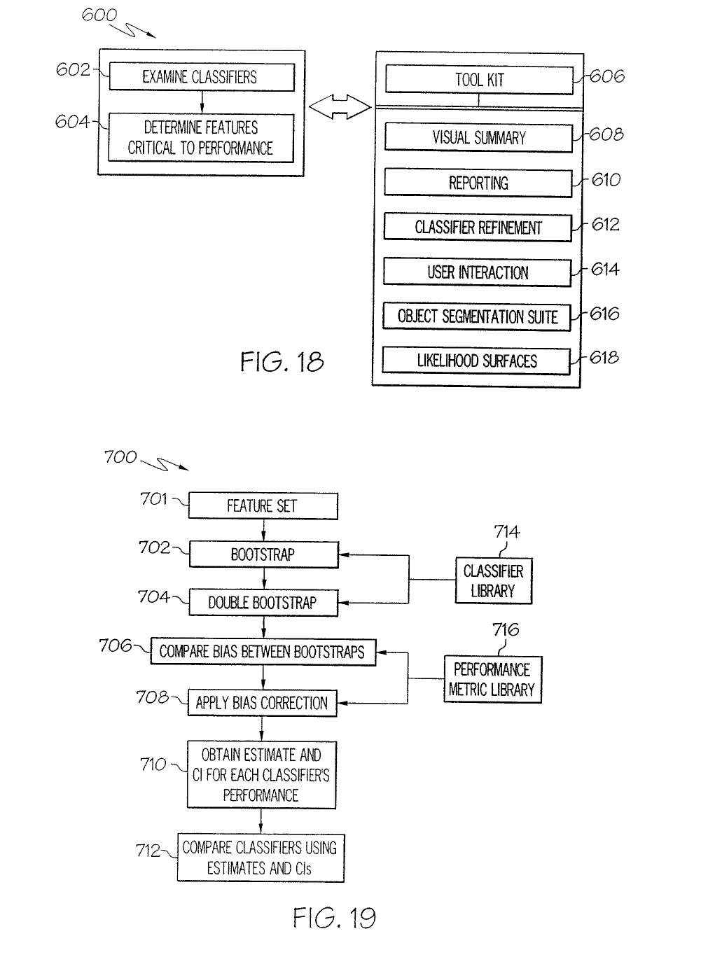

Referring to FIG. 18, a flow chart of the classifier refinement software 600 is illustrated. The process of refining a candidate classifier is potentially complex in practice. Data misclassified by the candidate classifier is studied at 602. The features most critical to the classifier's performance are also analyzed at 604. The software module of the present invention makes use of two paradigms to refine image classifiers. First, enough of the ‘art’ representing a candidate classifier methodology can be captured by an automated procedure to permit its exploration. Second, each existing and candidate feature can be represented visually and superimposed on the data being characterized.

These paradigms are applied across a collection of integrated tools 606 that permit a user to explore visually, those features that are critical to the reported classification performance, as well as to review those data objects misclassified by the current candidate classifiers. The software provides the user information regarding what features of the data are driving the current classifiers' performance and what commonalities of the currently misclassified images can be utilized to improve performance.

A first tool comprises visual summaries 608 of the performance observed for the candidate classifiers such as a cluster analysis of all the candidate classifiers' performance results. For example, the visual summaries can assume a fixed number of clusters reflecting the range of classifier complexities. Further, such a summary may optionally build on a number of existing tools, including the tools discussed herein. As suitable performance metrics are likely to vary across applications, this tool preferably accommodates the definition of additional metrics (i.e., pluggable performance metrics). The tool also preferably provides summaries comparing the results to any relevant performance specifications as well as determines whether sufficient data is available to train the more complex classifiers. If sufficient data is not available, an estimate is preferably provided as to the quantity of data required.

Another tool provides reporting/documentation 610 of which features are retained by classifiers with feature reduction capabilities by superimposing visual representations of the feature on example (or representative) data. As many instances of each candidate classifier will have been explored, the variability in a feature's weighting should be visually represented as a supplement to any false color provided to indicate average feature weight. For example, a user's request for an assessment of essential discriminating surfaces is provided, such as by generating two and three-dimensional scatterplots of selected features.

Further, the process distinguishes those features added/replaced as increasingly complex classifiers are considered. As a result, potential algorithm refinements or ‘noise’ prompting over-training of a candidate classifier (more likely with complex classifiers) can be identified. For example, the classifier refinement software 600 may be implemented within the effectiveness process 112 discussed herein with reference to FIGS. 1-6. The classifier refinement software 600 learns how to better pre-process data objects by examining the feature sets utilized by over-trained algorithms. Utilizing the feedback loops into the feature process 104 and training process 108, noise picked up by the classifier algorithms, can be reduced or eliminated.

A classifier refinement tool 612 provides visual summaries or representative display of misclassified images. Again, existing cluster analysis representations are converted to reflect images using generic features. The number of clusters is already known (i.e., number of classes) and the broad and diverse collection of cluster characterizations provides feedback to a user. For example, when requested by the user, the tool preferably indicates on each representative example, what features prompted misclassification. The tool preferably further allows a domain-aware user to indicate (e.g., lasso) a section of data indicating correct classification. For example, using any number of input output devices such as mouse, keyboard, digitizer, track ball, drawing tablet etc. a user identifies a correct classification on a data object, subsection of data, data from a related (or unrelated) data set, or from a representative data object.

An interactive tool 614 allows a domain-aware user to test how well the data can be classified. In effect, the user is presented with a representative sampling of the data and asked to classify them. The result is a check on the technology. For example, where the generic features prompt disappointing results, where the data is sufficiently poor, or where there is insufficient data for robust automatic classification, a user can provide human expert assistance to the classifiers through feedback and interaction.

Yet another tool comprises a data preprocessing and object segmentation suite 616. Preprocessing methods are used to reduce the computational load on the feature extraction process. For example, a suite of image preprocessing methods may be provided, such as edge detection, contrast enhancement, and filters. In many data applications, objects must be segmented prior to classification. Preferably, the software incorporates a suite of tools to enable the user to quickly select a segmenter that can segment out the objects of interest. For example, preprocessors can take advantage of an image API.

Preferably, the software uses likelihood surfaces 618 to represent data as features ‘see’ it. This indicates the characteristics of orthogonal features to those already being used by the classifiers. Further, the software makes use of ‘test’ images when appropriate. It should be appreciated that numerous classifier-specific diagnostics are well known in the art. Any such diagnostic techniques may be implemented in the present software.

The software of the present invention provides numerous visualizations applicable to the challenge of refining a candidate algorithm. The ability to indicate the characteristics of orthogonal features to those already being used and to visually represent the available image features provides a unique and robust module.

### Classifier Evaluation

The present invention incorporates a double bootstrap methodology implemented such that confidence intervals and estimates of classifier performance are derived from repeated evaluations. This methodology is preferably incorporated into the classifier refinement software 600 discussed with respect to FIG. 18, and further with the pattern recognition process 100 discussed with respect to FIGS. 1-6. Further, it should be appreciated that this approach may be utilized in stand-alone applications or in conjunction with other applications and methodologies derived at classifier evaluation.

The core to the method is an appreciation for the contention that the normal operating environment is data poor. Further, this embodiment of the invention recognizes that different classifiers can require vastly different amounts of data to be effectively trained. According to this classifier evaluation method, realistic, viable evaluations of the trained classifiers and associated technology performance are possible in both data rich and data poor environments. Further, this methodology is capable of accurately assessing variability of various performance quantities and correcting for biases in these quantities.

A flowchart for the method of classifier evaluation 700 is illustrated in FIG. 19. Estimates and/or confidence intervals that assess classifier performance are derived using a double bootstrap approach. This permits maximum and statistically valid utilization of often limited available data, and early stage determination of classifier success. Viable confidence intervals and/or estimates on classifier performance are reported, permitting realistic evaluation of where the classifier stands and how well the associated technology is performing. Further, the double bootstrap methodology is applicable to any number of candidate classifiers, and the classifier method reports a broad range of performance metrics including tabled, visual and visual summaries that allow rapid comparison of performance associated with candidate classifiers.

Where a significant quantity of data is available, the data is divided into a training data set, and a testing (evaluation) data set. The evaluation data set is held in reserve, and a classifier is trained on the training data set. The classifier is then tested using the evaluation data set. Under ideal conditions, the classifier should produce the expected classifier performance when evaluated using the testing data set. However, where the data available are limited, a bootstrap resampling approach establishes a sense of distribution, that is, how good or bad the classifier could be. A bootstrap process is computationally intensive, but not computationally difficult. It offers the potential for statistical confidence intervals on the true classifier performance.

A feature set 701 is used to extract feature vectors from a data set. A first bootstrap 702 comprises an approach of resampling that entails repeated sampling of the feature vectors extracted from the data set with replacement from the available data to derive both a training and evaluation set of data. These training and evaluation pairs are preferably generated at least 1000 times. At least one candidate classifier is developed using the training data and evaluated using the evaluation data. A second (or double) bootstrap 704 is conducted to allow the system to grasp the extent to which the first bootstrap is accurately reporting classifier performance. Preferably, the second bootstrap involves bootstrapping each of the first bootstrap training and evaluation data sets in the same or similar manner in which the first bootstrap derived the original training and evaluation data sets to obtain at least one associated double bootstrap training set and one associated double bootstrap evaluation set. A performance metric may also be derived for each of the first and second bootstraps.

The nature of bootstrap sampling engenders a bias in the characterized performance of classifiers. However, a double bootstrap allows the determination of the degree of bias. By examining the bias evident in the double bootstrap results, the bias in the original, or first bootstrap results can be estimated and removed. The cost in terms of system performance is that the double bootstrap at least doubles the computational burden of a single bootstrap approach, however, the cost is justified in that it improves reliability of sound estimates and confidence intervals.

The difference between the estimate for the first and second bootstraps are compared 706, and a bias correction is computed and applied to the bootstrap results 708. Correction must be robust to the broad nature of performance metrics being reported. For example, some metrics have defined maximums and minimums. These boundaries serve to stack the distribution of observed values making invalid simple corrections such as distribution shifts.

Once the bias correction is applied to the first bootstrap results, the system may obtain estimate and/or confidence intervals for each classifier's performance 710. This aspect of the present invention allows characterizations of the confidence associated with estimated classifier performance. This aspect further allows early stage decisions regarding viability of both the classifier methodology and the system within which it is to be implemented.

Using the estimates and the confidence intervals, the classifiers can be compared 712. This comparison may be used, for example, to select the optimal, or ultimate classifier for a given application. According to one embodiment of the present invention, comparisons of the estimates are used, but of primary interest is the lower confidence bound on classifier performance. The lower bound reflects a combination of the classifiers estimate of performance and the uncertainty involved with this estimate. The uncertainty will incorporate training problems in complex classifiers resulting from the limited available data. When there are not enough data available to train a complex classifier the estimate of performance may be overly optimistic; the lower confidence bound will not suffer from this problem and will reflect the performance that can truly be expected. It shall be appreciated that an optional classifier library 714, and/or an optional performance metric library 716 may be integrated in any implementation of the double-bootstrap approach to classifier evaluation.

Preferably, the double bootstrap method is implemented in a manner that facilitates integration with a broad number of candidate classifiers including for example, neural networks, statistical classification approaches and machine learning implementations. Further, classifier performance may optionally be reported using a range of metrics both visual and tabled. Visual summaries permit rapid comparison of the performance associated with many candidate classifiers. Further, tabled summaries are utilized to provide specific detailed results. For example, a range of reported classifier performance metrics can be reported in table form since the metric that best summarizes classifier performance is subjective. As another example, the desired performance metric may comprise a correlation between the predicted and observed relative frequencies for each category. This measure allows for the possibility that misclassifications can balance out.

It will be appreciated that any number of metrics can be reported to establish classifier performance. For example, according to one embodiment of the present invention, a detailed view of how the classifier is performing is provided for different categories. Also, the type of misclassifications that are being made is reported. Such views may be constructed for example, using confusion matrices to report the percentage of proper classifications as well as the percentage that were misclassified. The percentages may be reported by class, type, or any other pertinent parameter.

### Segmentation and the Segmentation Classifier

The selection of segments for feature selection may be accomplished in any number of ways, as set out herein. One preferred approach suited to certain applications is illustrated with respect to FIGS. 20A-20E. It should be appreciated that the segmentation approach discussed with reference to FIGS. 20A-20E may be implemented as a stand-alone method, may implemented using computer software or other means, and may be integrated into other aspects of the present invention described within this disclosure. For example, this segmentation approach may be integrated with, or used in conjunction with, the pattern recognition process 100 discussed with reference to FIGS. 1-6. In one exemplary application discussed more fully herein, the segmentation process may be integrated into the various embodiments of the pattern recognition construction system 100 discussed herein with reference to FIGS. 1-6 in a stage prior to the feature process 104 to build the training/testing data set 102. The segmentation process may also be incorporated for example, into the classifier evaluation tools discussed more fully herein to modify or revise the available data set.

The segmentation process according to one embodiment of the present invention focuses on building a segmentation classifier. Under this approach, the segmentation process considers which segments, parts, or aspects of a data object should be considered to determine whether a segment is worth considering within the data object. Thus the segmentation process is less concerned with identifying a particular class to which that segment belongs and is concerned with identifying whether a segment being analyzed is, or is not a segment of interest.

The segmentation process according to one embodiment of the present invention provides a set of tools that allow the efficient creation of a testing/training set of data when the objects of interest are contained within larger objects. For example, individual cells representing objects of interest may be contained within a single field of view. As another example, regions of interest may be contained within an aerial photo, etc. An aspect of the segmentation process is to create a segmentation classifier that may be used by other processes to assist in segmenting data objects for feature selection.

Referring initially to FIG. 20A, a block diagram of one implementation of the segmentation construction process 800 is illustrated. It shall be appreciated that, while discussed herein with reference to processes, each of the components discussed herein with reference to the segmentation construction process 800 may also be implemented as modules, or components within a system or software solution. Also, when implemented as a computer or other digital based system, the segments and data objects may be expressed as digitally stored representations thereof.

A group of training/testing data objects, or data set 802 are input into a segment select process 804. The segment select process 804 extracts segments where applicable, for each data object within the data set 802. The segment select process 804 is preferably arranged to selectively add new segments, remove segments that have been selected, and modify existing segments. The segment select process 804 may also be implemented as two separate processes, a first process to select segments, and a second process to extract the selected segments. The segment select process 804 may comprise a completely automated system that operates without, or with minimal human contact. Alternatively, the segment select process 804 may comprise a user interface for user guided selection of segments themselves, or of features that define the segments.

The optional segment library 806 can be implemented in any number of ways. However a preferred approach is the development of an extensible library that contains a plurality of segments, features, or other segment specific tools, preferably organized by domain or application. The extensible aspect allows new segmentation features to be added or edited by users, programmers, or from other sources.

The segment training process 808 analyzes the segments generated by the segment select process 804 to select and train an appropriate segment classifier or collection of classifiers. The approach used to generate the segment classifier or classifiers may be optionally generated from an extensible segment classifier library 810. The training process 804 is preferably arranged to selectively add new segment classifiers, remove select segment classifiers, retrain segment classifiers based upon modified classifier parameters, and retrain segment classifiers based upon modified segments or features derived therefrom. Further, the segment training process 808 may optionally be embodied in two processes including a classifier selection process to select among various candidate segment classifiers, and a training process arranged to train the candidate segment classifiers selected by the classifier selection process.

A segment effectiveness process 812 scrutinizes the progress of the segment training process 808. The segment effectiveness process 812 examines the segmentation classifier, and based upon that determination, the segment effectiveness process 812 reports classifier performance, for example, in terms of at least one performance metric, a summary, cluster, table, or other classifier comparison. The segment effectiveness process 812 further optionally provides feedback to the segment select process 804, to the segment training process 808, or to both.

It should be appreciated that no feedback may be required, or that feedback may be required for only the segment select process 804, or the segment training process 808. Thus a first feedback path provided from the segment effectiveness process 812 to the segment select process 804 is preferably independent from a second feedback path from the segment effectiveness process 812 to the segment training process 808. Depending upon the implementation of the segment effectiveness process 812, the feedback may be applied as a manual process, automatic process, or combination thereof. Through this feedback approach, a robust segmentation classifier 814 can be generated.

As the segmentation process 800 analyzes the data set 802, the prepared data 816 may optionally be filtered, converted, preprocessed, or otherwise manipulated as more fully described herein. As this approach shares several similarities to the pattern recognition construction process 100 described with reference to FIGS. 1-6, it should be observed that many of the tools described with reference thereto may be used to implement various aspects of the segmentation construction process 800. For example, selection tools, classifier evaluation tools and methodologies discussed herein, may be used to derive the segmentation classifier. Further, when the segmentation construction process 800 is used in conjunction with the pattern recognition construction process 100 discussed with reference to FIGS. 1-6, the data set 102 of FIGS. 1-6 may comprise the prepared data 816.

One approach to the segmentation process 800 is illustrated with reference to FIG. 20B. At least initially, a data object is contained within a field of view 850. The data object contained within the field of view 850 may comprise an entire data object, a preprocessed data object, or alternatively a subset of the data object. For example, where the data object is an image, the entire image may be represented in the field of view 850. Alternatively, a portion or area of the image is contained within the field of view 850. Areas of interest 852, 854, 856 as illustrated, are identified or framed. A user, a software agent, an automated process or any other means may perform the selection of the areas of interest 852, 854, 856.

It should be appreciated that any number of measures of interest may be identified across the data set. For example, a measure of interest may comprise a select area within a data object such as an image. As another example, the measure of interest may comprise a trend extracted across several data objects. As still another example, where the data objects comprise samples of a time varying signal, the measure of interest may comprise those data objects within a predetermined bounded range. Where the segmentation process 800 is implemented as a computer software program analyzing images for example, the areas of interest 852, 854, 856 are framed by selecting, dragging out, lassoing, or otherwise drawing the areas of interest 852, 854, 856 with a draw tool. Further, a mouse, pointer, digitizer or any other known input/output device may be used. Alternatively, a cursor, text or control box, or other command may be used to select the areas of interest 852, 854, 856. Alternatively, a fixed or variable pre-sized box, circle or other shape may frame the areas of interest 852, 854, 856. Yet another approach to framing the areas of interest 852, 854, 856 include the selection of a repetitive or random pattern. For example, if the data object is an image, a repetitive pattern of x by y pixels may be applied across the image, either in a predetermined or random pattern.

A software implementation of this approach may optionally highlight the pattern on the screen or display to assist the user in the selection process. Other approaches to determine the areas of interest include the use of correlation or cosine distance matching for segments of interest with other parts of the data. Another approach is to isolate the local max, or values above a particular threshold as regions of interest. Yet another approach is to use side information about the scale of interest to further refine areas of interest. Such an approach is useful, for example in the analysis of individual cells or cell masses. As an example, assuming all of the areas of interest are at least pixels wide and approximately circular, then segmentation should not conclude that there are two objects whose centers are much closer than 10 pixels. Further, any approach described herein with respect to feature selection and feature analysis may be used. Further, tools and techniques such as the feature set generation process 200 and other processes described herein with reference to FIGS. 7-19 may be used.

To assist in the training of segmentation classes, the framed areas of interest, 852, 854, 856 may be associated, or disassociated with a class. For example, as illustrated in FIG. 20B, the areas of interest 852, 854, 856 are analyzed in a system consisting of n current classes where n can be any integer. As illustrated, area of interest 852 is associated with a first class type 858. The area of interest 854 is associated with a second class type 860. The area of interest 856 is associated with a third class type 862. The first, second, and third class types 858, 860, and 862 can be a representation that the associated area of interest belongs to a particular class, or does not belong to a particular class, or more broadly, does not belong to a group of classes. For example, the third class type 862 may be defined to represent not belonging to any of the classes 1−n. As such, a segmentation algorithm may be effectively trained.

Features within the areas of interest 852, 854, 856 are measured. The features may be determined from a set of primitives, a subset of primitives, from a library such as the segmentation feature library 806 illustrated in FIG. 20A, a user, from a unique set of segmentation specific features or from any other source. It should be appreciated that one of the purposes of this approach is to focus on identifying what should be treated as a segment, and is less concerned with classifying the particular segment. Thus the features from the feature library or like source are preferably segment specific. Once the features are extracted, a segmentation classifier is used to classify the areas of interest. It should be appreciated that a number of approaches exist for establishing the areas of interest extracting and classifying the areas of interest including those approaches described more fully herein with respect to FIGS. 1-19.

Referring to FIG. 20C, the areas of interest may be segmented and optionally presented to the user, such as by clusters 864, 866, 868, 870. For example, the areas of interest may be clustered in certain meaningful relationships. One possible clustering may comprise a cluster of areas of interest that are disassociated with all n classes, or a subset of n classes. Other clusters would include areas of interest in a like class. As an additional optional aid to users, areas of interest derived from the training set may be highlighted or otherwise distinguished. It should be appreciated that any meaningful presentation of the results of the classification may be utilized. Further, more specific approaches to implement the classification of the segments may be carried out as more fully set out herein. For example, any of the effectiveness measurement tools described above may be implemented to analyze and examine the data.

A feedback loop is preferably provided so that a user, software agent or other source can alter the areas of interest originally selected. Additionally, parameters that define existing areas of interest may be edited. For example, the frame size, shape or other aspects may be adjusted to optimize, or otherwise improve the performance of the segmentation classifier. Referring to FIG. 20D, a view is preferably presented that provides a check, or otherwise allows a user to determine if anything was missed after segmentation. This view is used in conjunction with the feedback loop allowing performance evaluation and tweaking of the framed areas of interest, the features, and classifiers. Using this segmentation approach 800, the proper format for data sets may be ascertained, and established so that the data set may be used effectively by another process, such as any of the feature selection systems and processes discussed more thoroughly herein. The feedback and tweaking can continue until a robust segmentation classifier is established, or alternatively some other stopping criteria is met.

A segmentation approach 880 is illustrated in the flow chart of FIG. 20E. Data objects are placed in a field of view 882. Areas of interest are framed out 884, and features are measured 886. The areas of interest are then classified 888 to produce at least one segment classifier, and the results of the classification are identified 890, such as by providing a figure of merit, of performance metric describing the classification results. The process may then continue through feedback 892 to modify, add, remove, or otherwise alter the identified areas of interest, until a stopping criterion is met. For example, the process may iteratively refine the segment classifier based upon the performance measure until a stopping criterion is met by performing at least one operation to modify, add, and remove select ones of said at least one area of interest.

The use and advantages of the segmentation tools may be understood by way of example. In a particular application, cells are to be analyzed. The source of the data may comprise for example, a number of microscope scenes captured as images. Each image may have no cells, or any number of cells present. In order to build a classifier and feature set to classify cells in accordance with the discussions above with respect to FIGS. 1-19, a set of classified training images is preferably constructed. Thus a good set of training data must be built if it does not already exist. Assuming that the training data does not exist, the segmentation process 800 may be used to build such a training set.

The images generated by the microscope are input into the segment select process 804. Either through automatic process, through the assistance of a user, or a combination thereof, areas of interest are defined. This can comprise for example a user selecting all of the cells out of an image and identifying them as cells. Additionally, the user may extract an area of interest and identity it as not a cell. An area of interest may be associated as not belonging to group of classes, for example, a dust spot may be identified as not a cell. It is important to note that the cells may eventually be classified into the various types of cells, but the user need not be concerned with identifying to which class the cell belongs. Rather the user, software agent, automated process or the like need only be concerned with identifying that an area is, or is not, a cell generally. A segmentation classifier is generated using techniques described herein, and the user can optionally iterate the process until a satisfactory result is achieved.

A prepared data set 816 can also be generated. The use of a prepared data set 816 has a number of advantages thereto. For example, the data areas of interest can be extracted from the data object and stored independently. That is, each cell can be extracted individually and stored in a separate file. For example, where one image contains 10 cells, and numerous dust and other non-relevant portions, the dust and non-relevant portions may be set aside, and each of the cells may be extracted into their own unique file. Thus when the pattern recognition process 100 described with reference to FIGS. 1-19 analyze the training data set, the training set will comprise mostly salient objects of interest.

Further, the extraction process may perform data conversion, mapping or other preprocessing. For example, assume the outputs of the microscope comprise tiff images, but the feature process 104 of FIGS. 1-5 is expecting jpeg files in a certain directory. The prepared data set 816 can comprise performing image format conversion, and also handle the mapping of the correctly formatted data to the proper directory thus assisting in automating other related processes. It should be appreciated that any file conversions and data mapping may be implemented.

Once the areas of interest, the cells in the above example, are identified, an expert in the field can classify them. For example, a cytology expert, or other field specific expert classifies the data thus building a training set for the pattern recognition process 100 discussed with reference to FIGS. 1-6.

It should be pointed out that the segmentation process 800 discussed with reference to FIGS. 20A-20E might be operated automatically, by a user, by a software agent, or by a combination of the above. For example, a human user may teach the system how to distinguish dust from cells, and may further identify a number of varieties of cells. The system can then take over and automatically extract the pertinent areas of interest.

Further, other feature selection or extraction processes or systems, including those described more fully herein, may use the segmentation classifier built from the segmentation process. Finally, it should be appreciated that the above analysis is not limited to applications involving cells, but is rather directed towards any application where a segment classifier would be useful. Further, the segmentation process is useful for quickly building a training set where poor, or no previously classified data is available.

### The Extensible Feature API

The methods and systems discussed herein with references to FIGS. 1-15E provide a robust data analysis platform. Efficiency and effectiveness of that platform can be enhanced by utilizing a pluggable feature applications programming interface (API). Many aspects of the present invention, for example, feature extraction may optionally make effective use of a Data Analysis API. The API is preferably a platform independent module capable of implementation across any number of computer platforms. For example, the API may be implemented as a static or dynamic linked library. The API is useful in defining and providing a general description of an image feature, and is preferably utilized in conjunction with a graphic rich environment, such as a java interface interacting with the Java Advanced Imaging (JAI) 1.1 library developed by Sun Microsystems Inc. Further, the Data Analysis API may be used to provide access to analytic activities such as summarizing collections of images, exploratory classification of images based upon image characteristics, and classifying images based upon image characteristics.

Preferably, the Data Analysis API is pluggable. For example, pluggable features provide a group of classes, each class containing one or more algorithms that automate feature extraction of data. The pluggable aspect further allows the API to be customizable such that existing function calls can be modified and new function calls may be added. The scalability of the Data Analysis API allows new function calls to be created and integrated into the API.

The Data Analysis can be driven by a visual user interface (VUI) so the rich nature of any platform may be fully exploited. Further, the Data Analysis API allows for cache calculations in the classes themselves. Thus recalculations involving changes to a subset of parameters are accelerated. Preferably, one function call can serialize (externalize) classes and cache calculations.

Any number of methods may be used to provide interaction with the Data Analysis API, however, preferably, the output of each algorithm is retrievable as a double-dimensioned array with row and column labels that contain all feature vectors for all enabled records. Preprocessors are meant to add to or modify input image data before feature extraction algorithms are run on the data. It should be appreciated that the Data Analysis API may be implemented with multithreaded support so that multiple transactions may be processed simultaneously. Further, a user interface may be provided for the pluggable features that allow users to visually select API routines, and to interact with object parameters, weights, and request output for projections. Such an interface may be a standalone application, or otherwise incorporated into any of the programming modules discussed herein. For example, preprocessing routines may be provided for any number of data analysis transactions. For example, a process that automatically preprocesses the input data to return the gray plane, a processor that finds a color, finds the covariance matrix based on input plane data.

The Pluggable Features API is designed so that the configuration can be created or changed with few function calls. Calculations are cached in the Pluggable Features classes so that recalculations involving changes to a subset of parameters are accelerated. The classes and cached calculations can be serialized with one function call. The output of the feature extraction algorithm configuration can be retrieved as a doubly dimensioned array with row and column labels that contain all feature vectors for all enabled records.

Further, it should be observed that the computer-implemented aspects of the present invention may be implemented on any computer platform. In addition, the applications are networkable, and can split processes and modules across several independent computers. Where multi-computer systems are utilized, handshaking and other techniques are deployed as is known in the art. For example, the computation of classifiers is a processor intensive task. A computer system may dedicate one computer for each classifier to be evaluated. Further, the applications may be programmed to exploit multithreaded and multi-processor environments.

Having described the invention in detail and by reference to preferred embodiments thereof, it will be apparent that modifications and variations are possible without departing from the scope of the invention defined in the appended claims.

What is claimed is:

1. A computer system for performing directed dynamic analysis comprising:
at least one processor;
a storage device accessible by said processor arranged to store a data set comprising digital representations of a plurality of data objects;
an input device coupled to said processor configured to accept input from a user; and,
software executable by said at least one processor for:
iteratively exploring said data set at the object level by a user until a predetermined stopping criterion is met by performing for each iteration:
selecting by said user of at least two data objects from said data set;
providing by said user of at least one object level assessment that describes a relationship between said at least two data objects;
automatically taking diverse common measurements of features from said data objects based upon said at least one object level assessment and without further input from said user;
automatically constructing at least one of a rotation and a reweighting of said features based upon said at least one object level assessment and without further input from said user;
applying at least one of said rotation and said reweighting across at least a subset of said data set, and,
outputting at least one of a clustering, a projecting, and a summarizing of said subset in a manner that reflects said at least one object level assessment.

2. The computer system for performing directed dynamic analysis according to claim 1, wherein said software is further configured for outputting at least one of a feature set defining said features and feature vectors organizing the measured features.

3. The computer system for performing directed dynamic analysis according to claim 1, wherein said rotation is automatically constructed by:
constructing a data matrix comprising said diverse common measurements of features on each of said data objects;
extracting a sub-matrix from said data matrix comprising ones of said diverse common measurements for which said relationship is to be explored;
constructing a selection matrix that defines said relationship;
performing a canonical correlation computation using said sub-matrix and said selection matrix; and,
applying the rotations obtained from said canonical correlation computation across at least a portion of said data set.

4. A computer system for performing directed dynamic analysis comprising:
a storage device having a plurality of digital representations of data objects stored thereon;
an input device configured to accept input from a user;
a processor coupled to said storage device and said input device programmed to allow a user to iteratively explore said data set at the object level until a predetermined stopping criterion is met by executing for each iteration program code to:
allow said user to select at least two data objects from said data set;
receive as input from said user, at least one object level assessment that describes a relationship between said at least two data objects;
extract automatically, diverse common measurements of features from said data objects based upon said at least one object level assessment and without further input from said user;
construct automatically, at least one of a rotation and a reweighting of said features based upon said at least one object level assessment and without further input from said user;
apply at least one of said rotation and said reweighting across at least a subset of said data set, and,
output at least one of a cluster, a projection, and a summary of said subset in a manner that reflects said at least one object level assessment.

5. The computer system for performing directed dynamic analysis according to claim 4, wherein said processor further outputs at least one of a feature set defining said features and feature vectors organizing the measured features.

6. The computer system for performing directed dynamic analysis according to claim 4, wherein said processor is programmed to construct said rotation by executing code to:
construct a data matrix comprising said diverse common measurements of features on each of said data objects;
extract a sub-matrix from said data matrix comprising ones of said diverse common measurements for which said relationship is to be explored;
construct a selection matrix that defines said relationship;
perform a canonical correlation computation using said sub-matrix and said selection matrix; and,
apply the rotations obtained from said canonical correlation computation across at least a portion of said data set.

7. A computer readable carrier including dynamic data analysis program code that causes a computer to perform operations comprising:
selecting by a user of at least two data objects from a data set;
providing by said user of at least one object level assessment that describes a relationship between said at least two data objects;
automatically taking diverse common measurements of features from said data objects based upon said at least one object level assessment and without further input from said user;
automatically constructing at least one of a rotation and a reweighting of said features based upon said at least one object level assessment and without further input from said user; and,
applying at least one of said rotation and said reweighting across at least a subset of said data set.

8. The computer readable carrier according to claim 7, wherein said rotation is automatically constructed by:
constructing a data matrix comprising said diverse common measurements of features on each of said data objects;
extracting a sub-matrix from said data matrix comprising ones of said diverse common measurements for which said relationship is to be explored;
constructing a selection matrix that defines said relationship;
performing a canonical correlation computation using said sub-matrix and said selection matrix; and,
applying the rotations obtained from said canonical correlation computation across at least a portion of said data set.

9. A system for performing a directed dynamic data analysis comprising:
a processor;
a storage device accessible by said processor arranged to store a data set comprising digital representations of a plurality of data objects;
an input device coupled to said processor configured to accept input from a user; and,
software executable by said processor to derive a feature from said data set and to interact with a user for:
constructing a first matrix comprising select ones of said plurality of data objects, each having a plurality of measurements associated therewith;
constructing a second matrix describing the relationships between said select ones of said plurality of data objects in said first matrix;
applying a canonical correlations computation using said first and second matrices to derive at least one rotation; and,
outputting said at least one rotation across at least a portion of said data set.

10. The system for performing a directed dynamic data analysis according to claim 9, wherein said software further uses the results of said canonical correlations computation to cluster and display visually at least a portion of said data set.

11. A system for performing a directed dynamic data analysis comprising:
a storage device comprising a data set having a plurality of digital representations of data objects stored thereon;
an input device configured to accept input from a user; and,
a processor coupled to said storage device and said input device programmed to:
construct a first matrix comprising select ones of said plurality of data objects, each having a plurality of measurements associated therewith;
construct a second matrix describing the relationships between said select ones of said plurality of data objects in said first matrix;
apply a canonical correlations computation using said first and second matrices to derive at least one rotation; and,
output said at least one rotation across at least a portion of said data set.

12. The system for performing a directed dynamic data analysis according to claim 11, wherein said processor further executes instructions to cluster and display visually the results of said canonical correlations applied to at least a portion of said data set.

13. A computer readable carrier including a directed dynamic analysis program code that causes a computer to perform operations comprising:
constructing a first matrix comprising select ones of a plurality of data objects stored on a computer storage device, each having a plurality of measurements associated therewith;
constructing a second matrix describing the relationships between said select ones of said plurality of data objects in said first matrix;
applying a canonical correlations computation using said first and second matrices to derive at least one rotation; and,
outputting said at least one rotation across at least a portion of said data set.

14. A system for performing directed dynamic analysis comprising:
at least one processor;
a storage device accessible by said processor arranged to store a data set comprising digital representations of a plurality of data objects;
an input device coupled to said processor configured to accept input from a user; and,
software executable by said at least one processor to derive a feature from said data set and to interact with a user for:
creating a window on a display device defining a workspace;
outputting images representing at least a portion of said data set in said workspace;
reiteratively analyzing said data set until a predetermined stopping criterion is met by performing at least one of:
defining at least one rule comprising:
selecting a subset of said data objects;
defining a condition that describes said data objects in said subset; and,
assign a weight that established a measure of said condition;
outputting a new projection of said images by applying said at least one rule across said at least a portion of said data set, and,
modifying at least one rule.

15. The system for performing directed dynamic analysis according to claim 14, wherein each rule is selectively enabled and disabled, wherein said new projection of said images is defined by only applying enabled ones of each rule.

16. The system for performing directed dynamic analysis according to claim 14, wherein said projection is computed using a canonical correlation computation.

17. The system for performing directed dynamic analysis according to claim 14, wherein each rule defines an object level comparison.

18. The system for performing directed dynamic analysis according to claim 14, wherein said weight comprises a measure of similarity.

19. The system for performing directed dynamic analysis according to claim 18, wherein at least one setting of said weight comprises a neutral position.

20. A system for performing directed dynamic analysis comprising:
a storage device having a plurality of digital representations of data objects stored thereon;
an input device configured to accept input from a user; and,
a processor coupled to said storage device and said input device programmed to:
create a window on a display device defining a workspace;
output images representing at least a portion of said data set in said workspace;
analyze reiteratively said data set until a predetermined stopping criterion is met by performing at least one to:
define at least one rule comprising:
select a subset of said data objects;
define a condition that describes said data objects in said subset; and,
assign a weight that established a measure of said condition;
output a new projection of said images by applying said at least one rule across said at least a portion of said data set, and,
modify at least one rule.

21. The system for performing directed dynamic analysis according to claim 20, wherein each rule is selectively enabled and disabled, wherein said new projection of said images is defined by only applying enabled ones of each rule.

22. The system for performing directed dynamic analysis according to claim 20, wherein said projection is computed using a canonical correlation computation.

23. The system for performing directed dynamic analysis according to claim 20, wherein each rule defines an object level comparison.

24. The system for performing directed dynamic analysis according to claim 20, wherein said weight comprises a measure of similarity.

25. The system for performing directed dynamic analysis according to claim 20, wherein at least one setting of said weight comprises a neutral position.

26. A computer readable carrier including directed dynamic analysis program code that causes a computer to perform operations comprising:
creating a window on a display device defining a workspace;
outputting images representing at least a portion of a data set in said workspace;
reiteratively analyzing said data set until a predetermined stopping criterion is met by performing at least one of:
defining at least one rule comprising:
selecting a subset of said data objects;
defining a condition that describes said data objects in said subset; and,
assign a weight that established a measure of said condition;
outputting a new projection of said images by applying said at least one rule across said at least a portion of said data set, and,
modifying at least one rule.

27. A method of performing a directed dynamic analysis of a data set having a plurality of data objects by expert and non-expert users comprising:
iteratively exploring said data set at the object level by a user until a predetermined stopping criterion is met by performing for each iteration:
selecting by a user of at least two data objects from said data set;
providing by said user of at least one object level assessment that describes a relationship between said at least two data objects;
automatically taking diverse common measurements of features from said data objects based upon said at least one object level assessment and without further input from said user;
automatically constructing at least one of a rotation and a reweighting of said features based upon said at least one object level assessment and without further input from said user; and,
applying at least one of said rotation and said reweighting across at least a subset of said data set.

28. The method of performing a directed dynamic analysis according to claim 27, wherein said rotation is applied across at least said subset of said data set by performing at least one of clustering, projecting, and summarizing said subset in a manner that reflects said at least one object level assessment.

29. The method of performing a directed dynamic analysis according to claim 27, wherein said reweightings are applied across at least said subset of said data, and the reweighted data are analyzed by performing at least one of clustering, projecting, and summarizing said subset in a manner that reflects said at least one object level assessment.

30. The method of performing a directed dynamic analysis according to claim 27, wherein said rotation defines a weight for each feature that is commensurate with said at least one object level assessment.

31. The method of performing a directed dynamic analysis according to claim 30, wherein each reweighting defines weights that are commensurate with said at least one object level assessment.

32. The method of performing a directed dynamic analysis according to claim 27, further comprising providing as an output, at least one of a feature set that defines said features, and feature vectors organizing the measured features.

33. The method of performing a directed dynamic analysis according to claim 27, wherein said rotation is automatically constructed by:
constructing a data matrix comprising said diverse common measurements of features on each of said data objects;
extracting a sub-matrix from said data matrix comprising ones of said diverse common measurements for which said relationship is to be explored;
constructing a selection matrix that defines said relationship;
performing a canonical correlation computation using said sub-matrix and said selection matrix; and,
applying the rotations obtained from said canonical correlation computation across at least a portion of said data set.

34. A method of performing a directed dynamic data analysis on a data set having a plurality of data objects comprising:
constructing a data matrix comprising a plurality of measurements taken on each of said data objects;
extracting a sub-matrix from said data matrix comprising ones of said plurality of measurements for which a relationship is to be explored;
constructing a selection matrix that defines said relationship;
performing a canonical correlation computation using said sub-matrix and said selection matrix; and,
applying the rotations obtained from said canonical correlation computation across at least a portion of said data set.

35. The method of performing a directed dynamic data analysis on a data set having a plurality of data objects according to claim 34, wherein the rows of said data matrix correspond to said data objects and the columns of the data matrix correspond to the measurements of said data objects.

36. The method of performing a directed dynamic data analysis on a data set having a plurality of data objects according to claim 35, wherein said selection matrix comprises the same number of rows as said sub-matrix and the columns of said selection matrix correspond to the established relations.

37. The method of performing a directed dynamic data analysis on a data set having a plurality of data objects according to claim 34, wherein said relation comprise similarity and dissimilarity.

38. The method of performing a directed dynamic data analysis on a data set having a plurality of data objects according to claim 37, wherein similarity is assigned a value of one, and dissimilarity is assigned a value of zero.

39. The method of performing a directed dynamic data analysis on a data set having a plurality of data objects according to claim 34, wherein the rotations obtained from said canonical correlation computation are applied to said data set to create a visual clustering of said data set that reflects said relation.

40. A method of performing a directed dynamic data analysis on a data set having a plurality of data objects comprising:
constructing a first matrix comprising measurements associated with select ones of said plurality of data objects;
constructing a second matrix describing the relationships between said select ones of said plurality of data objects in said first matrix;
applying a canonical correlations computation using said first and second matrices to derive at least one rotation; and,
applying said at least one rotation across at least a portion of said data set.

41. The method of performing a directed dynamic data analysis on a data set having a plurality of data objects according to claim 40, further comprising constructing a data matrix having a plurality of measurements associated therewith, corresponding to the portion of said data set to which said at least one rotation is applied.

42. The method of performing a directed dynamic data analysis on a data set having a plurality of data objects according to claim 40, further comprising visually displaying the obtained rotations from said canonical correlations operations across at least a portion of said data set to create a visual clustering that reflects the relationships described in said second matrix.

43. The method of performing a directed dynamic data analysis on a data set having a plurality of data objects according to claim 40, wherein each row of said first matrix defines an object of said data set and each column defines a measurement corresponding to an associates one of said objects.

44. The method of performing a directed dynamic data analysis on a data set having a plurality of data objects according to claim 40, wherein a select one of said elements in said first matrix is denoted by the variable a and satisfies the condition that αᵢⱼ=λⱼ(Oᵢ) is the jth measurement on the ith object.

45. The method of performing a directed dynamic data analysis on a data set having a plurality of data objects according to claim 40, wherein said select ones of said plurality of objects selected from said first matrix comprise data objects for which a similarity measure is desired.

46. The method of performing a directed dynamic data analysis on a data set having a plurality of data objects according to claim 40, wherein said select ones of said plurality of objects selected for said first matrix comprise data objects for which an object level comparison is desired.

47. The method of performing a directed dynamic data analysis on a data set having a plurality of data objects according to claim 40, wherein said second matrix comprises a number of rows corresponding to the number of rows in said first matrix and at least one column that corresponds to a rule describing the relationships between the rows in said first matrix.

48. A method of deriving a feature from a data set having a plurality of data objects comprising:
constructing a data matrix Aₙₓₘ where αᵢⱼ∈R and αᵢⱼ=λⱼ/(Oᵢ) is the j^{th} measurement on the ith data object of said data set;
constructing a sub-matrix comprising at least two rows selected from said data matrix;
constructing a selection matrix comprising at least one column that establishes conditions that describe the relationship between said at least two rows in said sub-matrix;
applying a canonical correlation analysis to said sub-matrix and said selection matrix; and,
applying the resulting rotations of said canonical correlation analysis across at least a subset of said data set.

49. The method of deriving a feature from a data set having a plurality of data objects according to claim 48, wherein the results of said canonical correlation analysis are clustered and displayed visually.

50. A method of analyzing data objects comprising:
providing a data set having a plurality of data objects; organizing said data set in a first projection;
selecting at least two data objects from said data set;
providing at least one object level comparison that describes a relationship between said at least two data objects;
extracting said at least one object level comparison across said data set; and,
clustering said data set in a new projection that reflects the relationships described in said object level comparison.

51. A method of using a computer to perform directed dynamic analysis comprising:
projecting a data set in a workspace, said data set having a plurality of data objects;
selecting a subset of said data objects;
defining a rule that establishes a relationship between said data objects in said subset;
clustering said data set in said workspace based upon said rule; and,
re-projecting the clustered version of said data set in said workspace.

52. The method of using a computer to perform directed dynamic analysis according to claim 51, further comprising assigning a weight to said subset of said data objects, wherein said rule establishes said relationship based at least in part upon said weight.

53. A method of using a computer to perform directed dynamic analysis comprising:
projecting a data set in a workspace, said data set having a plurality of data objects;
defining at least one rule comprising:
selecting a subset of said data objects; and,
defining a condition that describes at least one relationship between said data objects in said subset;
defining a weight that establishes a measure of said condition; and,
performing at least one of:
creating a new projection of said data set by applying the rule across said data set, and,
modifying at least one rule.

54. The method of using a computer to perform directed dynamic analysis according to claim 53, wherein modifying a select one of said at least one rule comprises at least one of changing said data subset, changing said condition, enabling said rule, disabling said rule, and removing said rule.

55. The method of using a computer to perform directed dynamic analysis according to claim 53, further comprising performing at least one of:
creating a new projection of said data set by applying the rule across said data set, and,
modifying at least one rule.

56. The method of using a computer to perform directed dynamic analysis according to claim 53, wherein modifying a select one of said at least one rule comprises at least one of changing said data subset, changing said condition, enabling said rule, disabling said rule, and removing said rule.
